(19) United States
(12) Patent Application Publication
(10) Pub. No.: US 2014/0185867 A1
(43) Pub. Date: Jul. 3, 2014

(54) ANALYSIS SYSTEM AND ANALYSIS METHOD

(71) Applicant: BRIDGESTONE SPORTS CO., LTD., (US)

(72) Inventor: Tatsuya ISHIKAWA, Chichibu-shi (JP)

(73) Assignee: BRIDGESTONE SPORTS CO., LTD., Tokyo (JP)

(21) Appl. No.: 13/859,167

(22) Filed: Apr. 9, 2013

(30) Foreign Application Priority Data
May 22, 2012 (JP) 2012-116415

(51) Int. Cl. A63B 24/00; G06T 7/20

(52) U.S. Cl. CPC A63B 24/0006; G06T 7/20
USPC 382/103

(57) ABSTRACT

An object of the present invention is to enable accurate classification of golf swings. A data processing apparatus computes a state of motion of a golf ball on the basis of still images captured by an imaging unit. The data processing apparatus divides a golf swing identified by swing data acquired during a golf swing by a player into golf swing paths of a back swing, a down swing and a follow through, assigns a path in two-dimensional coordinates having a vertical axis and a horizontal axis to any two of these three golf swing paths, calculates an angle formed between the golf swing path and the horizontal axis, for each of the two golf swing paths, and classifies the golf swing on the basis of an angular difference between the respective angles thus calculated. The present invention can be applied to, for example, an analysis system for analyzing a golf swing.

### BACKGROUND OF THE INVENTION

1. Field of the Invention

The present invention relates to an analysis system and an analysis method, and in particular, to an analysis system and an analysis method which enable accurate classification of golf swings.

2. Description of the Related Art

In general, it is desirable that, when a golfer swings a golf club and strikes a golf ball (plays a shot) with the intention of causing the ball to fly in a straight direction, the direction of flight of the ball is relatively straight and does not deviate (is not liable to deviate). Each golfer should be able to relatively easily play a desirable shot of this kind by using a suitable golf club. However, in actual practice, it is not easy for a golfer to go into a shop and choose a golf club that suits him or her.

Therefore, in the prior art, research has been carried out into golf club design methods which make it possible to determine optimal club characteristics and an optimal club shape suited to the swing of each individual golfer (see, for example, Japanese Patent Application Publication No. H6-210027). According to Japanese Patent Application Publication No. H6-210027, apart from static characteristics such as the length of the golf club shaft (called “shaft” below), the balance, the weight of the club, the hardness of the shaft, and so on, the design elements of a golf club also include the bending rigidity of the shaft, the moment of inertia of the head, position of the center of gravity, and the shape (for example loft angle or lie angle), and the like, which all relate to the speed of the head, the angle of flight of the golf ball (also simply called “ball” below), the amount of spin, and the “hittability”, and hence these are key elements in the distance and direction of flight.

Furthermore, a golf club selection method has also been proposed, according to which information, such as information about the direction of upward and downward movement of the golf club head with respect to the horizontal plane immediately before striking the ball (impact) during the golf swing, and information about the direction of leftward and rightward movement of the golf club head in a plane parallel to the horizontal plane, immediately before striking the golf ball, is acquired, and this information is used to classify golf swings into predetermined types and to select a golf club suited to the classified type (see, for example, Japanese Patent Application Publication No. 2010-46539).

### SUMMARY OF THE INVENTION

However, even if a golf club design method is devised which can determine the optimal club characteristics and shape suited to an individual golfer's swing, using a plurality of parameters, as described in Japanese Patent Application Publication No. H6-210027, it takes a long time to custom-design the golf club. Therefore, a golfer is not able to go into a store, choose a golf club that suits him or her, and make a decision about the club.

Furthermore, if a classification method such as that described in Japanese Patent Application Publication No. 2010-46539 is used as a method for classifying golf swing types in a relatively simple fashion, then this classification is made on the basis of information about the direction, and the like, of the golf club head immediately before impact, and therefore information relating to the swing up to a time close to the moment of impact is not taken into consideration at all in making the classification and hence there is room for improvement in the accuracy of classification.

The present invention was devised in view of the foregoing, an object thereof being to enable accurate classification of golf swings.

The analysis system according to a first aspect of the present invention is an analysis system which analyzes a golf swing when a player strikes a golf ball with a golf club, comprising:

a head measurement apparatus which measures a head speed of the golf club when striking the golf ball;

an imaging unit which captures still images used for computing a state of motion of the golf ball on the basis of the head speed measured by the head measurement apparatus;

an acquisition apparatus which acquires swing data, which is data during a golf swing of the player; and

a data processing apparatus which analyzes the golf swing on the basis of the swing data and also computes the state of motion of the golf ball on the basis of the still images captured by the imaging unit,

wherein the data processing apparatus includes:

a measurement unit which divides the golf swing identified by the swing data into golf swing paths of a back swing, a down swing and a follow through, and assigns a path in two-dimensional coordinates having a vertical axis and a horizontal axis, to any two golf swing paths among the back swing, the down swing and the follow through;

a characteristic amount extraction unit which calculates an angle formed between the golf swing path and the horizontal axis, for each of the two golf swing paths; and

a statistical processing unit which classifies the golf swing on the basis of an angular difference between the respective angles thus calculated.

The analysis method according to a first aspect of the present invention is an analysis method for an analysis system that includes:

a head measurement apparatus which measures a head speed of a golf club when a player strikes a golf ball with the golf club;

an imaging unit which captures still images on the basis of the head speed measured by the head measurement apparatus;

an acquisition apparatus which acquires swing data, which is data during a golf swing of the player; and

a data processing apparatus which analyzes the golf swing on the basis of the swing data and also computes a state of motion of the golf ball on the basis of the still images captured by the imaging unit,

the analysis method comprising:

a process in which the head measurement apparatus measures the head speed of the player, the imaging unit captures the still images used for computing the state of motion of the golf ball on the basis of the measured head speed, and the data processing apparatus computes the state of motion of the golf ball on the basis of the still images captured by the imaging unit; and

a process in which the acquisition apparatus acquires the swing data; and the data processing apparatus: divides the golf swing identified by the swing data into golf swing paths of a back swing, a down swing and a follow through, and assigns a path in two-dimensional coordinates having a vertical axis and a horizontal axis, to any two golf swing paths among the back swing, the down swing and the follow through; calculates an angle formed between the golf swing path and the horizontal axis, for each of the two golf swing paths; and classifies the golf swing on the basis of an angular difference between the respective angles thus calculated.

In the first aspect of the present invention, a process is carried out in which: the head measurement apparatus measures the head speed of the player, the imaging unit captures the still images used for computing the state of motion of the golf ball on the basis of the measured head speed, and the data processing apparatus computes the state of motion of the golf ball on the basis of the still images captured by the imaging unit; and a process is carried out in which: the acquisition apparatus acquires the swing data; and the data processing apparatus divides the golf swing identified by the swing data into golf swing paths of a back swing, a down swing and a follow through, assigns a path in two-dimensional coordinates having a vertical axis and a horizontal axis to any two golf swing paths among the back swing, the down swing and the follow through, calculates an angle formed between the golf swing path and the horizontal axis, for each of the two golf swing paths, and classifies the golf swing on the basis of an angular difference between the respective angles thus calculated.

The analysis system according to a second aspect of the present invention is an analysis system which analyzes a golf swing when a player strikes a golf ball with a golf club, comprising:

an imaging unit which captures a plurality of still images close to a moment of impact when the golf club is swung;

an acquisition apparatus which acquires swing data, which is data during a golf swing of the player; and

a data processing apparatus which analyzes the golf swing on the basis of the swing data and also measures a behavior of a face of a club head of the golf club on the basis of the still images captured by the imaging unit,

wherein the data processing apparatus includes:

a storage unit which stores a positional relationship between at least three markers arranged on the club head of the golf club, and the face of the club head; and

a computation unit which measures the behavior of the face of the club head during a swing on the basis of positions of the markers contained in the captured still images, by using the positional relationship stored in the storage unit; and

the computation unit includes:

a measurement unit which divides the golf swing identified by the swing data into golf swing paths of a back swing, a down swing and a follow through, and assigns a path in two-dimensional coordinates having a vertical axis and a horizontal axis, to any two golf swing paths among the back swing, the down swing and the follow through;

a characteristic amount extraction unit which calculates an angle formed between the golf swing path and the horizontal axis, for each of the two golf swing paths; and

a statistical processing unit which classifies the golf swing on the basis of an angular difference between the respective angles thus calculated.

The analysis method according to a second aspect of the present invention is an analysis method for an analysis system that includes:

an imaging unit which captures a plurality of still images close to a moment of impact when a golf club is swung by a player;

an acquisition apparatus which acquires swing data, which is data during a golf swing of the player; and

a data processing apparatus which analyzes the golf swing on the basis of the swing data and also measures a behavior of a face of a club head of the golf club on the basis of the still images captured by the imaging unit,

the analysis method comprising:

a process in which the imaging unit captures a plurality of still images close to the moment of impact when the golf club is swung; and the data processing apparatus measures the behavior of the face of the club head during a swing on the basis of positions of at least three markers arranged on the club head of the golf club and contained in the captured still images, by using a positional relationship between the markers and the face of the club head, this positional relationship being previously stored in a storage unit; and

a process in which the acquisition apparatus acquires the swing data; and the data processing apparatus: divides the golf swing identified by the swing data into golf swing paths of a back swing, a down swing and a follow through, and assigns a path in two-dimensional coordinates having a vertical axis and a horizontal axis, to any two golf swing paths among the back swing, the down swing and the follow through; calculates an angle formed between the golf swing path and the horizontal axis, for each of the two golf swing paths; and classifies the golf swing on the basis of an angular difference between the respective angles thus calculated.

In the second aspect of the present invention, a process is carried out in which: the imaging unit captures a plurality of still images close to the moment of impact when the golf club is swung; and the data processing apparatus measures the behavior of the face of the club head during a swing on the basis of positions of at least three markers arranged on the club head of the golf club and contained in the captured still images, by using a positional relationship between the markers and the face of the club head, this positional relationship being previously stored in a storage unit, and a process is carried out in which: the acquisition apparatus acquires the swing data; and the data processing apparatus divides the golf swing identified by the swing data into golf swing paths of a back swing, a down swing and a follow through, assigns a path in two-dimensional coordinates having a vertical axis and a horizontal axis, to any two golf swing paths among the back swing, the down swing and the follow through, calculates an angle formed between the golf swing path and the horizontal axis, for each of the two golf swing paths, and classifies the golf swing on the basis of an angular difference between the respective angles thus calculated.

The analysis system according to a third aspect of the present invention is an analysis system which analyzes a golf swing when a player strikes a golf ball with a golf club, comprising:

a head measurement apparatus which measures a head speed of the golf club when striking the golf ball;

an imaging unit which captures still images used for computing a state of motion of the golf ball on the basis of the head speed measured by the head measurement apparatus;

an acquisition apparatus which acquires swing data, which is data during a golf swing of the player; and

a data processing apparatus which analyzes the golf swing on the basis of the swing data and also computes the state of motion of the golf ball on the basis of the still images captured by the imaging unit,

wherein the data processing apparatus includes:

a measurement unit which divides the golf swing identified by the swing data into golf swing paths of a back swing, a down swing and a follow through, and assigns a path in two-dimensional coordinates having a vertical axis and a horizontal axis, to any two golf swing paths among the back swing, the down swing and the follow through;

a characteristic amount extraction unit which calculates a distance in a horizontal direction between any two points on the golf swing path, for each of the two golf swing paths; and

a statistical processing unit which classifies the golf swing on the basis of a distance difference between the respective distances in the horizontal direction thus calculated.

The analysis method according to a third aspect of the present invention is an analysis method for an analysis system that includes:

a head measurement apparatus which measures a head speed of a golf club when a player strikes a golf ball with the golf club;

an imaging unit which captures still images on the basis of the head speed measured by the head measurement apparatus;

an acquisition apparatus which acquires swing data, which is data during a golf swing of the player; and

a data processing apparatus which analyzes the golf swing on the basis of the swing data,

the analysis method comprising:

a process in which the head measurement apparatus measures the head speed of the player, the imaging unit captures the still images used for computing the state of motion of the golf ball on the basis of the measured head speed, and the data processing apparatus computes the state of motion of the golf ball on the basis of the still images captured by the imaging unit; and

a process in which the acquisition apparatus acquires the swing data; and the data processing apparatus: divides the golf swing identified by the swing data into golf swing paths of a back swing, a down swing and a follow through, and assigns a path in two-dimensional coordinates having a vertical axis and a horizontal axis, to any two golf swing paths among the back swing, the down swing and the follow through; calculates a distance in a horizontal direction between any two points on the golf swing path, for each of the two golf swing paths; and classifies the golf swing on the basis of a distance difference between the respective distances in the horizontal direction thus calculated.

In the third aspect of the present invention, a process is carried out in which: the head measurement apparatus measures the head speed of the player, the imaging unit captures the still images used for computing the state of motion of the golf ball on the basis of the measured head speed, and the data processing apparatus computes the state of motion of the golf ball on the basis of the still images captured by the imaging unit; and a process is carried out in which: the acquisition apparatus acquires the swing data; and the data processing apparatus divides the golf swing identified by the swing data into golf swing paths of a back swing, a down swing and a follow through, assigns a path in two-dimensional coordinates having a vertical axis and a horizontal axis to any two golf swing paths among the back swing, the down swing and the follow through, calculates a distance in a horizontal direction between any two points on the golf swing path, for each of the two golf swing paths, and classifies the golf swing on the basis of a distance difference between the respective distances in the horizontal direction thus calculated.

The analysis system according to a fourth aspect of the present invention is an analysis system which analyzes a golf swing when a player strikes a golf ball with a golf club, comprising:

an imaging unit which captures a plurality of still images close to a moment of impact when the golf club is swung;

an acquisition apparatus which acquires swing data, which is data during a golf swing of the player; and

a data processing apparatus which analyzes the golf swing on the basis of the swing data and also measures a behavior of a face of a club head of the golf club on the basis of the still images captured by the imaging unit,

wherein the data processing apparatus includes:

a storage unit which stores a positional relationship between at least three markers arranged on the club head of the golf club, and the face of the club head; and

a computation unit which measures the behavior of the face of the club head during a swing on the basis of positions of the markers contained in the captured still images, by using the positional relationship stored in the storage unit; and

the computation unit includes:

a measurement unit which divides the golf swing identified by the swing data into golf swing paths of a back swing, a down swing and a follow through, and assigns a path in two-dimensional coordinates having a vertical axis and a horizontal axis, to any two golf swing paths among the back swing, the down swing and the follow through;

a characteristic amount extraction unit which calculates a distance in a horizontal direction between any two points on the golf swing path, for each of the two golf swing paths; and

a statistical processing unit which classifies the golf swing on the basis of a distance difference between the respective distances in the horizontal direction thus calculated.

The analysis method according to a fourth aspect of the present invention is an analysis method for an analysis system that includes:

an imaging unit which captures a plurality of still images close to a moment of impact when a golf club is swung by a player;

an acquisition apparatus which acquires swing data, which is data during a golf swing of the player; and

a data processing apparatus which analyzes the golf swing on the basis of the swing data and also measures a behavior of a face of a club head of the golf club on the basis of the still images captured by the imaging unit,

the analysis method comprising:

a process in which the imaging unit captures a plurality of still images close to the moment of impact when the golf club is swung; and the data processing apparatus measures the behavior of the face of the club head during a swing on the basis of positions of at least three markers arranged on the club head of the golf club and contained in the captured still images, by using a positional relationship between the markers and the face of the club head, this positional relationship being previously stored in a storage unit; and

a process in which the acquisition apparatus acquires the swing data; and the data processing apparatus: divides the golf swing identified by the swing data into golf swing paths of a back swing, a down swing and a follow through, and assigns a path in two-dimensional coordinates having a vertical axis and a horizontal axis, to any two golf swing paths among the back swing, the down swing and the follow through; calculates a distance in a horizontal direction between any two points on the golf swing path, for each of the two golf swing paths; and classifies the golf swing on the basis of a distance difference between the respective distances in the horizontal direction thus calculated.

In the fourth aspect of the present invention, a process is carried out in which: the imaging unit captures a plurality of still images close to the moment of impact when the golf club is swung; and the data processing apparatus measures the behavior of the face of the club head during a swing on the basis of positions of at least three markers arranged on the club head of the golf club and contained in the captured still images, by using a positional relationship between the markers and the face of the club head, this positional relationship being previously stored in a storage unit, and a process is carried out in which: the acquisition apparatus acquires the swing data; and the data processing apparatus divides the golf swing identified by the swing data into golf swing paths of a back swing, a down swing and a follow through, assigns a path in two-dimensional coordinates having a vertical axis and a horizontal axis, to any two golf swing paths among the back swing, the down swing and the follow through, calculates a distance in a horizontal direction between any two points on the golf swing path, for each of the two golf swing paths, and classifies the golf swing on the basis of a distance difference between the respective distances in the horizontal direction thus calculated.

According to the first to fourth aspects of the present invention, it is possible to classify a golf swing accurately.

Moreover, according to the first and third aspects of the present invention, it is possible to measure the head speed and the ball speed during a golf swing, more accurately. Furthermore, according to the second and fourth aspects of the present invention, it is possible to measure the behavior of the club head during a golf swing, accurately, in a simpler fashion.

### BRIEF DESCRIPTION OF THE DRAWINGS

FIGS. 1A and 1B are block diagrams showing an example of the composition of a first embodiment of a measurement system to which the present invention is applied;

FIG. 2 is a diagram showing an example of the arrangement of respective apparatuses in the measurement system shown in FIGS. 1A and 1B;

FIG. 3 is a diagram showing an example of the arrangement of respective apparatuses in the measurement system shown in FIGS. 1A and 1B;

FIG. 4 is a diagram illustrating preparations for head behavior measurement using a registration plate;

FIGS. 5A and 5B are diagrams illustrating preparations for head behavior measurement using a registration plate;

FIGS. 6A to 6D are diagrams illustrating items which are measured in head behavior measurement processing;

FIGS. 7A and 7B are diagrams illustrating items which are measured in head behavior measurement processing;

FIG. 8 is a diagram illustrating an example of a measurement result display screen;

FIGS. 9A to 9D are diagrams illustrating predictive calculations at the moment of impact;

FIG. 10 is a flowchart illustrating preparatory processing for head behavior measurement;

FIG. 11 is a flowchart illustrating preparatory processing for head behavior measurement;

FIG. 12 is a diagram illustrating a relationship between two Doppler sensors in a measurement apparatus and their measurement ranges;

FIG. 13 is a flowchart illustrating a measurement processing based on impact measurement mode;

FIGS. 14A and 14B are block diagrams showing an example of the composition of a second embodiment of a measurement system to which the present invention is applied;

FIG. 15 is a diagram illustrating a positional relationship between a first moving image camera and a second moving image camera;

FIG. 16 is a functional block diagram showing an approximate composition of a data processing apparatus according to the second embodiment;

FIG. 17 is a diagram showing one example of a golf club which is used in the second embodiment;

FIGS. 18A to 18C are diagrams for describing a golf swing;

FIG. 19 is a diagram showing one example of measurement results according to a second embodiment;

FIG. 20 is a diagram showing one example of measurement results according to a second embodiment;

FIG. 21 is a diagram showing one example of classification results according to a second embodiment;

FIG. 22 is a flowchart illustrating a database creation process performed by the measurement system according to the second embodiment;

FIG. 23 is a flowchart illustrating a swing classification process performed by the measurement system according to the second embodiment; and

FIG. 24 is a block diagram showing an example of the composition of one embodiment of a computer to which the present invention is applied.

### DESCRIPTION OF THE PREFERRED EMBODIMENTS

### Compositional Example of First Embodiment of Measurement System

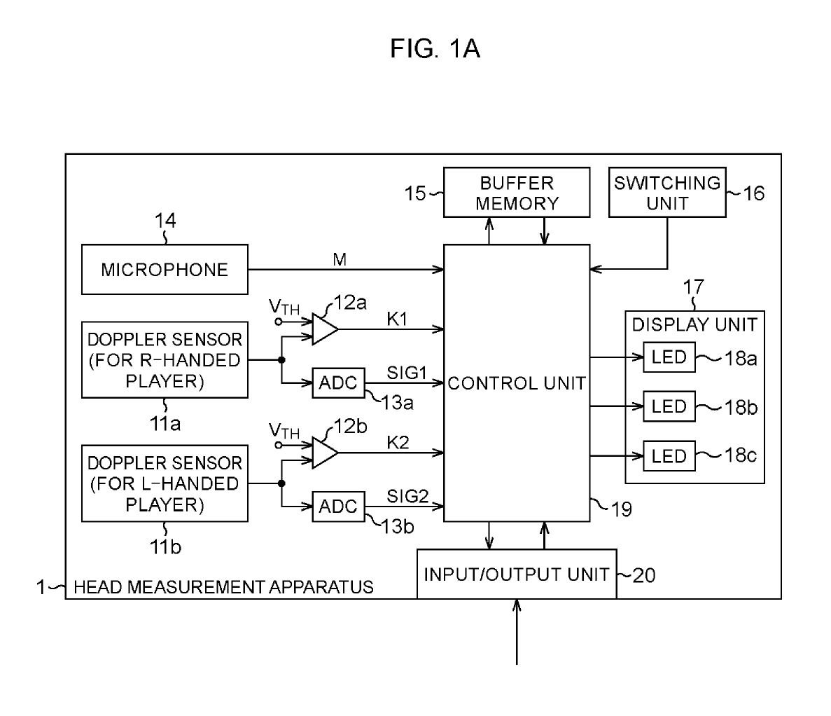

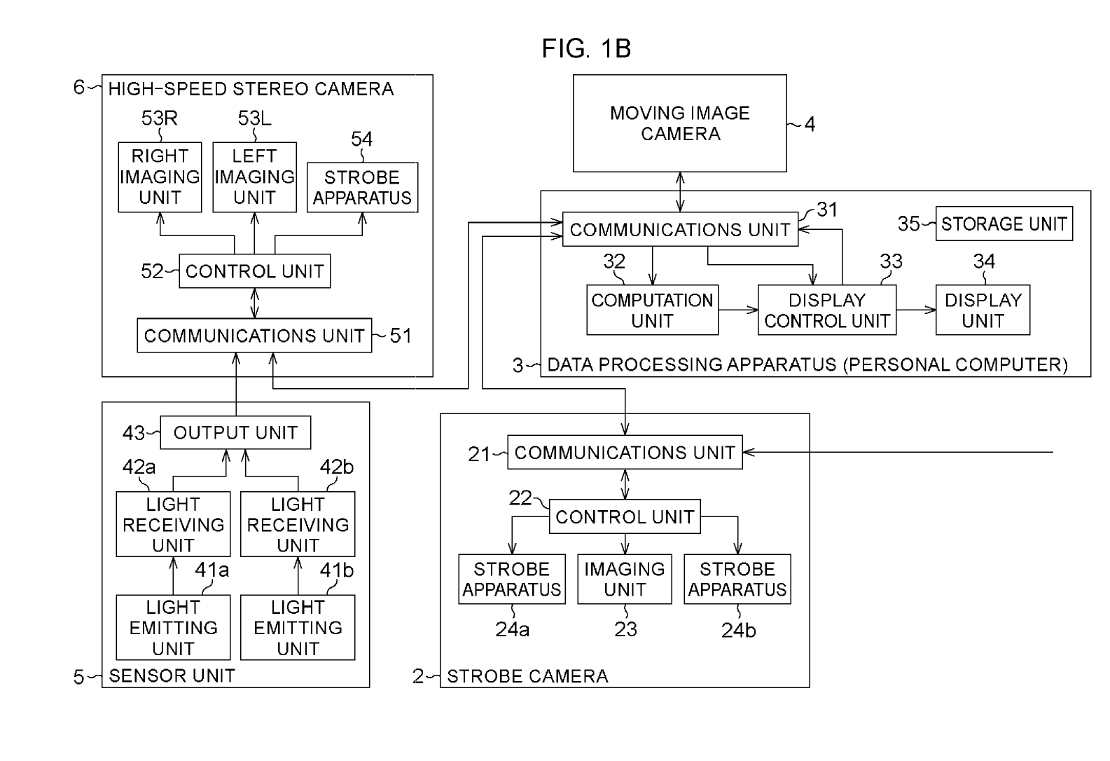

FIGS. 1A and 1B show a compositional example of a first embodiment of a measurement system to which the present invention is applied.

The measurement system in FIGS. 1A and 1B has a head measurement apparatus 1, a strobe camera 2, a data processing apparatus 3, a moving image camera 4, a sensor unit 5 and a high-speed stereo camera 6, and is a system which simultaneously measures a velocity of a golf club, which is a striking object, and a velocity of a golf ball, which is a struck object, when a player (subject) swings a golf club and strikes a golf ball situated at a prescribed position. Below, the velocity of the golf club is also called the head speed, and the velocity of the golf ball is also called the ball speed.

The measurement system in FIGS. 1A and 1B includes a Doppler measurement system which measurement the head speed using a Doppler sensor 11 in the head measurement apparatus 1, and a laser measurement system which measures the head speed using a laser sensor in the sensor unit 5.

The Doppler measurement system measures the head speed, and also captures images of the golf ball immediately after impact and analyzes the state of motion of the golf ball by using the captured images obtained as a result of this.

This Doppler measurement system has an impact measurement mode (first Doppler measurement mode) which measures and displays the velocities of the golf club and the golf ball at the moment that the golf ball is struck by the golf club, and a with-image measurement mode (second Doppler measurement mode) which also captures and displays images of the whole of the player's swing action, in addition to measurement of the velocities of the golf club and the golf ball.

On the other hand, the laser measurement system measures the head speed, and also captures images of the club head close to the moment of impact on the basis of the measured head speed, and analyzes the behavior of the club head (the head of the golf club) by using the captured images.

Consequently, in the measurement system in FIGS. 1A and 1B, the head speed can be measured by both the Doppler measurement system and the laser measurement system. The measurement system in FIGS. 1A and 1B may set the measurement result of one or both of the Doppler measurement system and the laser measurement system as the final measurement value, or may set a calculation result, such as the average, based on the two calculation results, as the final measurement value.

Firstly, the composition of the Doppler measurement system will be described.

The Doppler measurement system is constituted by the head measurement apparatus 1, the strobe camera 2, the data processing apparatus 3, and the moving image camera 4.

The head measurement apparatus 1 includes two Doppler sensors 11, two comparators 12, and two ADC (A/D converters) 13. The Doppler sensors 11 each output a microwave signal as a transmission signal, and when the output transmission signal is reflected by a prescribed object, changing the frequency of the signal, each receive the reflected signal which has a prescribed Doppler frequency (called the “Doppler signal” below). The frequency of the transmission signal output by the Doppler sensor 11 is 24.11 GHz, for example. The comparator 12 compares the output level of the Doppler signal received by the Doppler sensor 11 with a predetermined reference level V_{TH}, and if this output level is equal to or greater than the reference level V_{TH}, then the comparator 12 outputs a detection signal K1 or K2 indicating detection of the object under measurement. The ADC 13 performs analog-digital (AD) conversion of the Doppler signal output by the Doppler sensors 11 to a prescribed number of bits (for example, 16 bits), and outputs a digital Doppler signal, SIG1 or SIG2, after AD conversion.

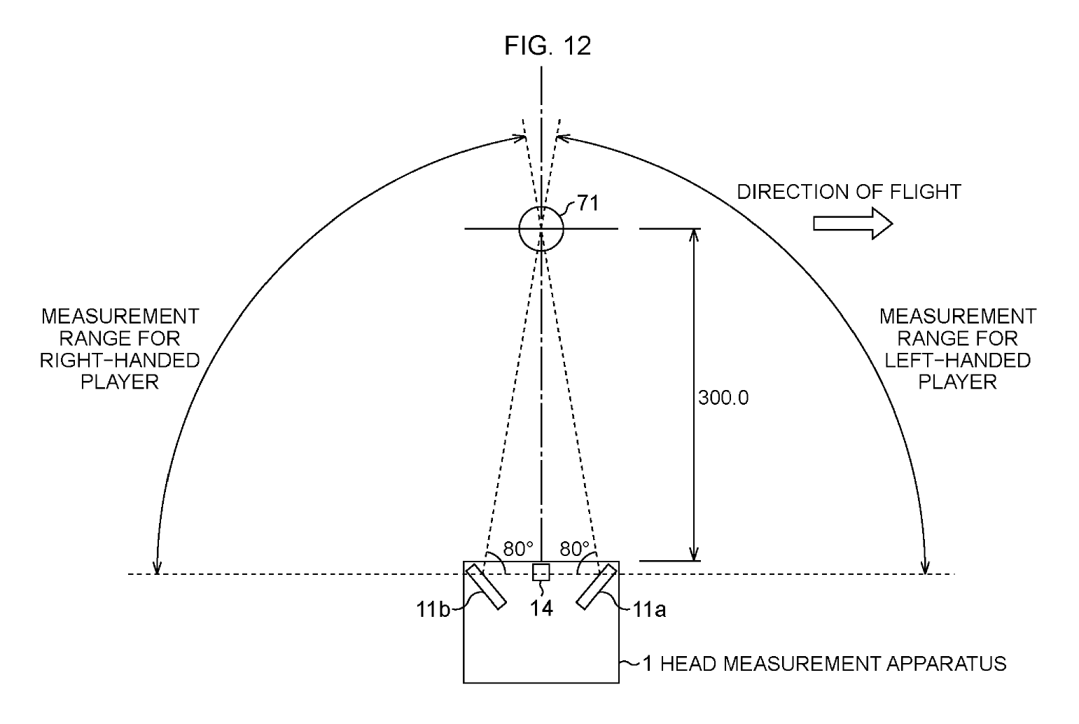

One each of the two Doppler sensors 11, comparators 12 and ADCs 13 is used for head speed detection for a right-handed player and the others are used for head speed detection for a left-handed player. In the present embodiment, the Doppler sensor 11a, the comparator 12a and the ADC 13a are set for use with right-handed players, and the Doppler sensor 11b, the comparator 12b and the ADC 13b are set for use with left-handed players. The difference between the elements for a right-handed player and a left-handed player relates to the different installation position of the Doppler sensor 11 in the head measurement apparatus 1, and detailed description thereof is given below with reference to FIG. 12.

Below, the description mainly relates to a case where setup is made for a right-handed player, and portions which are different in the case of a setup for a left-handed player are described appropriately as and where necessary.

The head measurement apparatus 1 also has a microphone 14, a buffer memory 15, a switching section 16, a display section 17, a control unit 19 and an input/output unit 20.

The microphone 14 detects the timing of the moment of impact, in other words, the timing of the moment when the golf ball, which is the struck object, is struck by the golf club, which is the striking object, by acquiring a sound signal M when the golf ball, which is the struck object, is struck by the golf club, which is the striking object.

Under the control of the control unit 19, the buffer memory 15 stores the Doppler signal SIG1 output from the Doppler sensor 11a or the Doppler signal SIG2 output from the Doppler sensor 11b, up to a prescribed data volume corresponding to a previously established measurement time. The buffer memory 15 is a ring buffer, and if a new Doppler signal equal to or greater than the reference level V_{TH} is supplied, then the stored data of a prescribed volume is updated, sequentially, from the oldest data. More specifically, in the case of a right-handed setup, for example, the Doppler signal SIG1 is written in order from the smallest address, and when signals have been written to the whole of the data region, then the new signals are written over the old signals, starting from the oldest data (in other words, starting from the smallest address), so that the newest Doppler signals SIG1 for a prescribed volume (prescribed time period) are stored in the buffer memory 15. In the case of a left-handed setup, the Doppler signal SIG2 is stored in the buffer memory 15, according to a similar procedure, rather than the Doppler signal SIG1.

The switching unit 16 is constituted by a DIP switch, for example, and is used to switch between operational setup for a right-handed player and a left-handed player. In other words, the switching unit 16 switches the object of calculation of the velocity of the golf club, which is performed by the control unit 19, to either a Doppler signal from the Doppler sensor 11a, or a Doppler signal from the Doppler sensor 11b. The switching between operational setup for a right-handed player and operational setup for a left-handed player may also be performed by connecting the data processing apparatus 3 to the head measurement apparatus 1, and using a control signal supplied from the data processing apparatus 3 to the input/output unit 20. In this case, the switching unit 16 may also be omitted.

The display unit 17 includes three LEDs 18a to 18c, and switches the LEDs 18a to 18C on and off on the basis of a control signal from the control unit 19. The first LED 18a switches on when the Doppler sensor 11a detects an object (golf club). The second LED 18b switches on when an impact is detected. The third LED 18c switches on when the Doppler sensor 11a detects an object (golf club) and when an impact is detected within a prescribed time period from the detection of the object. In other words, the third LED 18c switches on when the second LED 18b has switched on during a prescribed time period after the switching on of the first LED 18a. Although described in detail below, the switching on of the third LED 18c means that the head speed computed by the control unit 19 has been output to the strobe camera 2.

The three LEDs 18a to 18c may provide a blinking display, or the like, instead of simply lighting up. Furthermore, it is also possible to transmit a control signal which controls the switching on of the three LEDs 18a to 18c, to the data processing apparatus 3, and to cause a display unit 34 of the data processing apparatus 3 (described hereinafter) to show a display similar to that of the LEDs 18a to 18c. In this case, the display unit 17 may be omitted.

The control unit 19 controls the Doppler signals SIG1 and SIG2 on the basis of the settings of the switching unit 16. In other words, when a right-handed operation setup has been made by the switching unit 16, the control unit 19 starts writing the Doppler signal SIG1 supplied from the ADC 13a, to the buffer memory 15, from the time that the detection signal K1 indicating detection of an object (club head) is supplied from the comparator 12a. The control unit 19 starts computation of the head speed when sufficient data (of the Doppler signal SIG1) for measurement of the head speed has been stored in the buffer memory 15. The computation of the head speed is carried out whenever a new Doppler signal SIG1 is supplied to the buffer memory 15. In other words, by also updating the head speed in accordance with change in the Doppler signal SIG1, the newest head speed calculated at a timing close to impact is determined at all times.

The head speed can be determined by the common Doppler effect formula shown below.

v=(c·F_{d})/(2·Fₜ)

Here, c is the speed of light (299792485 m/s), F_{d} is the frequency of the received Doppler signal SIG1 (Doppler frequency) and Fₜ is the output frequency of the Doppler sensor 11a.

Furthermore, the control unit 19 transmits the head speed measured immediately previously, to the strobe camera 2, via the input/output unit 20, when the moment of impact is detected by a sound signal M from the microphone 14 within a prescribed time period after the detection signal K1 has been supplied. Moreover, the control unit 19 terminates (halts) the writing of the Doppler signal SIG1 to the buffer memory 15, after the head speed, which is the measurement result, has been sent to the strobe camera 2.

Moreover, the control unit 19 controls the switching on of the LEDs 18a to 18c in the display unit 17. More specifically, the control unit 19 switches on the first LED 18a when the detection signal K1 is supplied from the comparator 12a, and switches on the second LED 18b when the sound signal M is supplied from the microphone 14 within a prescribed time period after the supply of the detection signal K1. The control unit 19 switches on the third LED 18c when the head speed, which is the measurement result, is output to the strobe camera 2. Furthermore, the control unit 19 also controls the switching off of the LEDs 18a to 18c.

In this way, by switching on the LEDs 18a to 18c respectively so as to correspond to the detection of the golf club, the detection of the moment of impact, and the output of the head speed, which is the measurement result, it becomes possible to see at a glance whether or not measurement data has been acquired correctly.

When a left-handed operational setup has been made by the switching unit 16, the control unit 19 carries out similar control using the detection signal K2 and the Doppler signal SIG2, instead of the detection signal K1 and the Doppler signal SIG1 described above. Consequently, one each of the two Doppler sensors 11, comparators 12 and ADCs 13 which are provided is unused, depending on whether a right-handed setup or a left-handed setup is made. If the head measurement apparatus 1 is for right-handed use only or for left-handed use only, then the switching unit 16, and the unnecessary Doppler sensor 11, comparator 12 and ADC 13 are omitted and costs can be reduced.

The strobe camera 2 includes a communications unit 21, a control unit 22, an imaging unit 23 and a strobe apparatus 24. Two strobe apparatuses 24 are provided and these are distinguished as strobe apparatuses 24a and 24b.

The communications unit 21 is connected to the input/output unit 20 of the head measurement apparatus 1, and the head speed measured by the head measurement apparatus 1 is acquired and supplied to the control unit 22. Furthermore, the communications unit 21 is connected to the communications unit 31 of the data processing apparatus 3 and (data of) two images captured by the imaging unit 23 and supplied from the control unit 22 is sent to the data processing apparatus 3.

The control unit 22 specifies the timing of two image capturing actions performed by the imaging unit 23, on the basis of the head speed measured by the head measurement apparatus 1, which is supplied from the communications unit 21, and the control unit 22 controls the imaging unit 23 and the strobe apparatuses 24 on the basis of the specified timing.

More specifically, the communications unit 22 specifies a first image capture timing and a second image capture timing (a time interval from the first image capture timing until the second image capture timing), on the basis of the head speed supplied from the communications unit 21. The control unit 22 then controls the strobe apparatus 24a to emit strobe light and controls the imaging unit 23 to perform image capture, when the first image capture timing thus specified is reached. Furthermore, the control unit 22 also controls the strobe apparatus 24b to emit strobe light and controls the imaging unit 23 to perform image capture, when the second image capture timing thus specified is reached. By this means, two images captured at different timings are obtained of the golf ball immediately after impact. In other words, when the imaging unit 23 captures two images on the basis of the head speed supplied from the communications unit 21, the image capture timings are specified by the control unit 22 in such a manner that the golf ball is captured in the respective images. The control unit 22 outputs the two images obtained by the two image capturing actions, together with the head speed measured by the head measurement apparatus 1, to the data processing apparatus 3 via the communications unit 21.

The imaging unit 23 is constituted by a charge coupled device (CCD) camera or a complementary metal oxide semiconductor (CMOS) sensor camera, and performs image capture at the image capture timings specified by the control unit 22, and supplies two images obtained as a result of this to the control unit 22. The two images obtained by image capture by the imaging unit 23 are used by the computation unit 32 of the data processing apparatus 3 in order to compute the state of motion (speed) of the golf ball immediately after impact.

The strobe apparatus 24 is an illumination apparatus capable of emitting strobe light, and emits strobe light at the image capture timings instructed by the control unit 22 so as to irradiate light onto the golf ball. The strobe apparatus 24a is a strobe apparatus 24 for the first image capturing action, and the strobe apparatus 24b is a strobe apparatus 24 for the second image capturing action.

The data processing apparatus 3 is constituted by a communications unit 31, a computation unit 32, a display control unit 33, a display unit 34 and a storage unit 35. The data processing apparatus 3 may be constituted by a personal computer, for example.

The communications unit 31 sends and receives data based on a prescribed data format, between the strobe camera 2 and the moving image camera 4. More specifically, the communications unit 31 receives the head speed supplied from the strobe camera 2, and the two images captured immediately after impact, and supplies these to the computation unit 32, in addition to which, in the with-image measurement mode, the communications unit 31 also acquires moving image data obtained by capturing images of the player's swing action which are supplied from the moving image camera 4 and supplies these to the display control unit 33. Furthermore, the communications unit 31 sends a control command supplied from the display control unit 33, to the moving image camera 4.

The computation unit 32 supplies the head speed which is measured by the head measurement apparatus 1 and supplied via the strobe camera 2, to the display control unit 33. The head speed may also be supplied directly to the display control unit 33 from the communications unit 31.

Furthermore, the computation unit 32 calculates the state of motion of the golf ball, and more specifically, at least one of the velocity, number of revolutions per unit time and direction of rotation, of the golf ball, from the two images of the golf ball captured by the strobe camera 2 immediately after impact, and supplies this information to the display control unit 33. In the impact measurement mode according to the present embodiment, at least the velocity of the golf ball is determined.

The velocity of the golf ball, the number of revolutions of the golf ball per unit time and the direction of rotation of the golf ball, can be calculated by a method such as the following, for example. Golf balls often have letters and/or marks (logos) indicating the maker's name or the brand name on the surface of the ball. The computation unit 32 determines a portion of a letters or marks on the surface of the golf ball as a characteristic point. The computation unit 32 then calculates the distance of movement, the number of revolutions and the direction of revolution of the golf ball, by comparing the positions of corresponding characteristics points in the first image which is obtained by the first image capturing action and in the second image which is obtained by the second image capturing action. The velocity of the golf ball is found by dividing the movement distance of the golf ball by the imaging time interval between the first image and the second image. The imaging time interval between the first image and the second image can be acquired together with the two images, from the strobe camera 2. The detailed method of calculating the velocity of the golf ball, and the number of revolutions of the golf ball per unit time and the direction of revolution of the golf ball, is disclosed in Japanese Patent Application Publication No. 2009-247642, for example.

The velocity of the golf ball determined by the computation unit 32 and the number of revolutions and direction of revolution of the golf ball are supplied to the display control unit 33, together with the head speed which is the measurement result from the head measurement apparatus 1.

In the impact measurement mode, the display control unit 33 causes the display unit 34 to display both the velocity of the golf club and the velocity of the golf ball.

Furthermore, the display control unit 33 can also cause the display unit 34 to display a meet rate, which is obtained by dividing the velocity of the golf ball (ball speed) [m/s] by the velocity of the golf club (head speed) [m/s], as well as the velocity of the golf club and the velocity of the golf ball. Moreover, the display control unit 33 may also cause the display unit 34 to display the standard flight distance of the golf ball which is determined by a prescribed calculation formula using the ball speed. The standard flight distance of the golf ball can be calculated by (ball speed [m/s]×3.8) [yard], for example.

Moreover, in the with-image measurement mode, the display control unit 33 superimposes the velocity of the golf club and the velocity of the golf ball which have been determined by the computation unit 32, on a moving image of the player's swing action which is acquired from the moving image camera 4 via the communications unit 31, and causes the display unit 34 to display the resulting image. Alternatively, the display control unit 33 may measure the trajectory of the golf ball (the path of the flying ball), from the velocity, number of revolutions and direction of revolution of the golf ball determined by the computation unit 32, and may cause the display unit 34 to display this information.

In order to identify the image of the moment of impact, from the moving images of a prescribed time period which capture the player's swing action, it is possible to use the following method, for example. A timing signal (sound signal M) indicating that impact has been detected is supplied from the head measurement apparatus 1 to the data processing apparatus 3 via the strobe camera 2. In this case, the input/output unit 20 of the head measurement apparatus 1 starts a count operation by an internal counter, simultaneously with outputting a timing signal to the strobe camera 2. The display control unit 33 of the data processing apparatus 3 acquires a timing signal, via the strobe camera 2, and recognizes that an impact has been detected, as well as reading in a count value of the input/output unit 20 and acquiring the amount of delay due to communications (the time difference between the output of the timing signal by the input/output unit 20 and the recognition by the display control unit 33). The display control unit 33 shows the image captured by the moving image camera 4 at a timing which is earlier than the timing of reception of the timing signal, by the delay amount, as the image of the time of impact. Therefore, it is possible accurately to identify the image at the time of impact from the moving images of the whole of the swing action captured by the moving image camera 4, and the display control unit 33 causes the display unit 34 to display a prescribed number of captured images before and after the image at the time of impact, as moving images of the whole swing action. It is also possible to connect the head measurement apparatus 1 and the data processing apparatus 3 directly, without passing via the strobe camera 2, and to acquire the timing signal and the count value directly from the head measurement apparatus 1.

The display unit 34 is constituted by a liquid crystal display, for example, and in the impact measurement mode, displays the velocity of the golf club and the velocity of the golf ball. Furthermore, in the with-image measurement mode, the display unit 34 also displays moving images of the player's swing operation and the trajectory of the golf ball.

If the velocity arising from the computation result is exactly the same as the previous computation result, then there may be cases where it is not possible to tell whether the result is that of the previous measurement display or is the result of a new measurement. Therefore, when the newest measurement result is displayed, it is possible to indicate the fact that the display of measurement results has been updated by causing the measurement result to be displayed in a blinking fashion, for a prescribed initial time period.

The storage unit 35 stores data that needs to be stored, such as the data of the measurement results, and so on. In FIGS. 1A and 1B, the lines which indicate transfer of data or control signals to and from the storage unit 35 are not depicted.

The moving image camera 4 is constituted by a video camera or a video still camera capable of capturing moving images, or the like, and in the with-image measurement mode, the moving image camera 4 captures images in accordance with the control of the data processing apparatus 3 and supplies the moving image data during the player's golf swing obtained as a result of this image capture, to the data processing apparatus 3, as swing data. The image capture timing of each image which constitutes the moving images is included as metadata in the moving image data supplied from the moving image camera 4 to the data processing apparatus 3. If the apparatus is used in impact measurement mode only, then the moving image camera 4 can be omitted.

Next, the composition of the laser measurement system will be described.

The laser measurement system is constituted by the data processing apparatus 3, the sensor unit 5 and the high-speed stereo camera 6.

The sensor unit 5 includes light emitting units 41a and 41b, light receiving units 42a and 42b, and an output unit 43. The light emitting units 41a and 41b are constituted by the same unit, and are simply called the light emitting unit 41, if neither one of the light emitting units 41a and 41b is to be specified in particular. The light receiving units 42a and 42b are both constituted by the same unit, and both of the light receiving units 42a and 42b are referred to, similarly, as light receiving unit 42.

The light transmitting unit 41 emits laser light by a semiconductor laser, or the like. The light receiving unit 42 receives laser light emitted from the corresponding light transmitting unit 41, and furthermore supplies, to the output unit 43, a detection signal indicating that a prescribed object has been detected, if the laser light is shielded by the passage of the prescribed object between the light emitting unit 41 and the light receiving unit 42 and hence the light receiving unit 42 has become unable to receive the laser light. The light receiving unit 42a receives laser light from the light transmitting unit 41a and if the light is shielded, supplies the first detection signal to the output unit 43. On the other hand, the light receiving unit 42b receives laser light from the light transmitting unit 41b and if the light is shielded, supplies the second detection signal to the output unit 43.

The output unit 43 outputs detection signals supplied respectively from the light receiving units 42a and 42b (first or second detection signals) to the high-speed stereo camera 6.

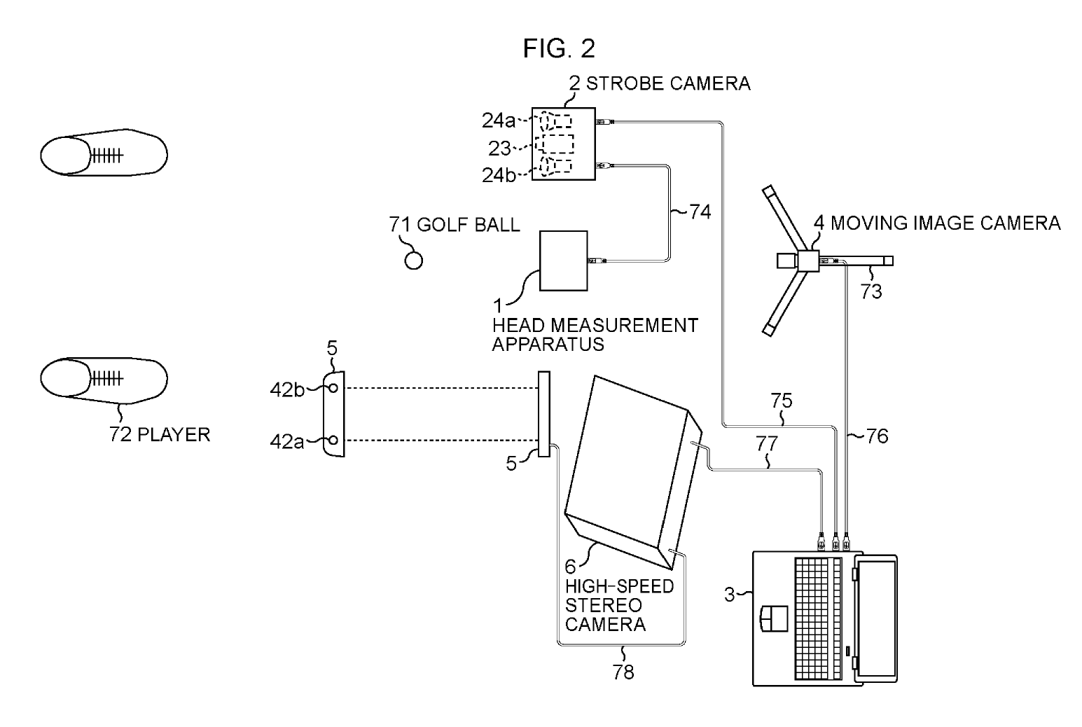

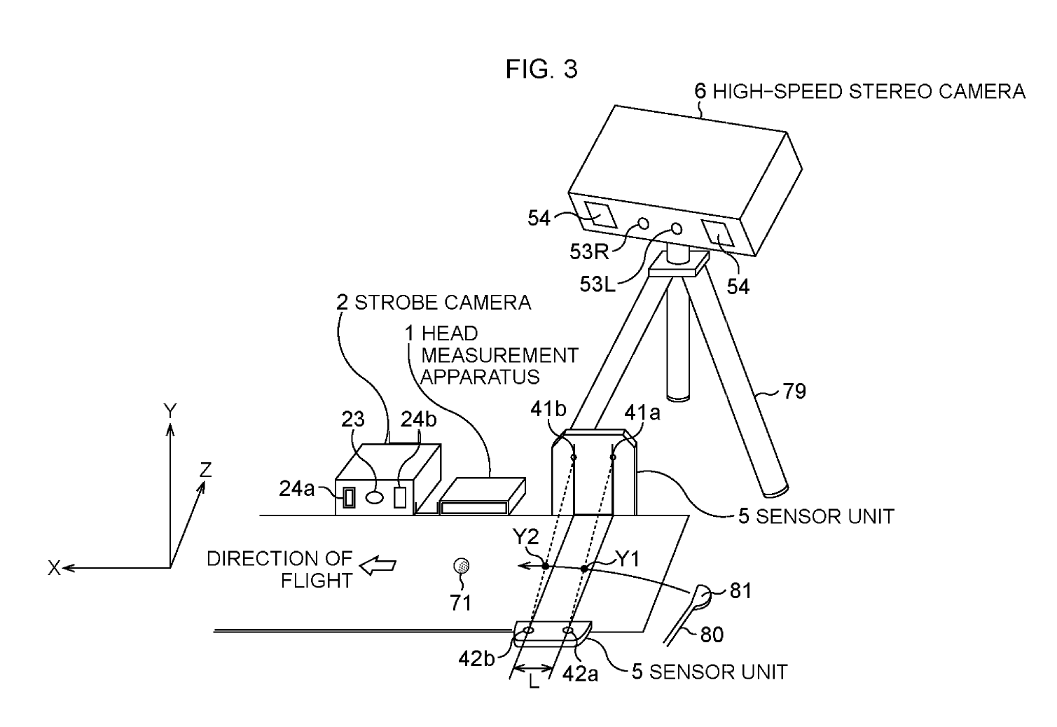

In the present embodiment, the prescribed object which shields the laser light is a club head (the head of a golf club) when swung by a player so as to strike a golf ball, as described below with reference to FIG. 2 and FIG. 3. Consequently, the sensor unit 5 outputs the first detection signal and the second detection signal indicating that a club head has been detected, to the high-speed stereo camera 6.

The high-speed stereo camera 6 is constituted by a communications unit 51, a control unit 52, a right imaging unit 53R, a left imaging unit 53L and a strobe apparatus 54.

The communications unit 51 receives a detection signal supplied from the sensor unit 5 and supplies the signal to the control unit 52. Furthermore, the communications unit 51 acquires the measurement value of the head speed supplied from the control unit 52, and the captured images obtained by image capture by the right imaging unit 53R and the left imaging unit 53L, and supplies the measurement value and captured images to the data processing apparatus 3.

Furthermore, the control unit 52 measures the head speed from the time difference between the times at which the first detection signal and the second detection signal are supplied from the sensor unit 5.

Moreover, the control unit 52 specifies a time period T1 from the timing at which the second detection signal is acquired until the start of imaging (hereinafter, called a delay time T1), on the basis of the measured head speed. When a delay time T1 has elapsed from the timing at which the second detection signal was acquired, the control unit 52 controls the right imaging unit 53R, the left imaging unit 53L and the strobe apparatus 54 so as to perform a first image capturing action, and to then subsequently perform four image capturing actions leaving an image capture interval of T2 between each.

In other words, the head speed differs for each player and the time period from the detection of the detection signal until the impact differs with the head speed. Thereupon, the control unit 52 predicts the moment (timing) of impact on the basis of the measured head speed and specifies the delay time corresponding to this. The control unit 52 implements control in such a manner that, in one measurement operation, a total of five image capturing actions are performed, one image capture closest to the moment of impact (the fifth image capturing action), and four image captures immediately prior to this.

In the present embodiment, the time period T2, which is the image capture interval, is set to a fixed (prescribed) time period, but the time period T2 may also be controlled so as to change appropriately on the basis of the measurement value of the head speed. When the time period T2 is changed appropriately on the basis of the measurement value of the head speed, then the interval between the measurement points is uniform, regardless of the head speed, and therefore the analysis results can be compared more easily.

The right imaging unit 53R and the left imaging unit 53L respectively carry out imaging in accordance with imaging instructions from the control unit 52, and the images captured as a result of this are supplied to the control unit 52. In the present embodiment, a total of five image capturing actions are carried out respectively by the right imaging unit 53R and the left imaging unit 53L, and therefore a total of five sets of captured images are obtained, each set consisting of a right captured image obtained by the right imaging unit 53R and a left captured image obtained by the left imaging unit 53L. The right imaging unit 53R and the left imaging unit 53L are arranged at prescribed intervals apart in a lateral direction (horizontal direction) as shown in FIG. 3, which is described hereinafter.

The strobe apparatus 54 emits strobe light at the timing that the right imaging unit 53R and the left imaging unit 53L perform image capture, in accordance with a light emission command from the control unit 52.

In order to perform image capture of the club head which is moving at high speed, five times very close to the moment of impact, the high-speed stereo camera 6 which is composed as described above is a high-speed stereo camera having, for example, a shutter speed of about 1/50000 of a second and a frame rate of about 500 fps, or is a camera capable of high-speed image capture sufficient to operate the shutter five or more times during one exposure.

The computation unit 32 of the data processing apparatus 3 which forms the laser measurement system supplies the head speed measured and supplied by the high-speed stereo camera 6, to the display control unit 33. As described above, the computation unit 32 utilizes either one or both of the head speed measured by the head measurement apparatus 1 and the head speed measured by the high-speed stereo camera 6, or may supply an average of these head speeds, for instance, to the display control unit 33 as the final head speed.

The computation unit 32 of the data processing apparatus 3 analyzes the behavior (state of motion) of the club head, from the five sets of images captured by the high-speed stereo camera 6, and supplies an image showing the result of this analysis, to the display control unit 33. The behavior of the club head which is analyzed by the computation unit 32 involves, more specifically, an entry angle α of the club head, a blow angle β, a face angle γ and a dynamic loft δ, and these are described in detail below.

The display control unit 33 of the data processing apparatus 3 causes the display unit 34 to display the analysis image supplied from the computation unit 32.

The storage unit 35 of the data processing apparatus 3 stores data that needs to be stored, such as the results calculated by the computation unit 32.

### [Example of Arrangement of Measurement System]

Next, the arrangement of the respective apparatuses which constitute the measurement system in FIGS. 1A and 1B, and the positional relationship between the golf ball and the player, will be described with reference to FIG. 2 and FIG. 3.

FIG. 2 is a diagram showing the respective apparatuses of the measurement system in FIGS. 1A and 1B and the positional relationship between the golf ball and the player, as viewed from the upper surface. FIG. 2 is an example of a case where a player is right-handed.

FIG. 3 is a perspective diagram of the respective apparatuses of the measurement system shown in FIGS. 1A and 1B, as viewed from the side of a right-handed player. In FIG. 3, the data processing apparatus 3 and the moving image camera 4 are omitted from the drawing.

As shown in FIG. 2, when a player's (feet) 72 are situated facing the golf ball 71, the head measurement apparatus 1 is disposed at a distant position on the far side of the golf ball 71 from the player, on a straight line which links the player 72 and the golf ball 71, and the moving image camera 4 is disposed at a more distant position on the far side of the head measurement apparatus 1. In other words, the player 72, the golf ball 71, the head measurement apparatus 1 and the moving image camera 4 are arranged in this order on an approximate straight line. The moving image camera 4 is fixed to a tripod 73.

The strobe camera 2 is disposed alongside the head measurement apparatus 1, on the side of the direction of flight of the ball. The arrangement position of the strobe camera 2 is set to the optimal position in accordance with the image capture timing of the strobe camera 2. For example, it may be arranged in stacked fashion above the head measurement apparatus 1, so as to achieve virtually simultaneous timing with the moment of impact.

The high-speed stereo camera 6 is disposed alongside the head measurement apparatus 1, on the side opposite to the direction of flight of the ball.

As shown in FIG. 3, the head measurement apparatus 1, the strobe camera 2 and the sensor unit 5 are each situated on the ground where the golf ball 71 is situated, whereas the high-speed stereo camera 6 is disposed at a position slightly higher than the ground, due to the tripod 79, in order to capture images of the golf ball 71 and the club head 81 of the golf club 80 from the upper side.

As shown in FIG. 3, the sensor unit 5 is arranged on either side of a position through which the club head 81 passes when the golf club 80 is swung by the player 72, and is disposed in such a manner that the unit on the side of the light transmitting section 41 and the unit on the side of the light receiving section 42 are mutually opposing.

In the present embodiment, as shown in FIG. 3, a three-dimensional coordinates system is set by taking the point where the golf ball 71 is situated as the point of origin, taking the direction of flight of the ball as the X axis, taking the vertical direction which is perpendicular to the ground surface where the golf ball 71 is situated, as the Y axis, and taking the direction from the golf ball 71 towards the head measurement apparatus 1, which is perpendicular to the X axis, as the Z axis.

The light emitting unit 41a and the light receiving unit 42a, and the light receiving unit 41b and the light receiving unit 42b, are arranged at a distance L apart in the X axis direction. When the club head 81 passes the position Y1 in FIG. 3, the laser light from the light emitting unit 41a is shielded and the first detection signal is output. Furthermore, when the club head 81 passes the position Y2 in FIG. 3, the laser light from the light emitting unit 41b is shielded and the second detection signal is output. The head speed can be measured by using the time period from the time that the club head 81 passes the position Y1 until the time that the club head 81 passes the position Y2, and the known distance L.

The laser sensor of the sensor unit 5 may employ a reflective type of sensor or a line sensor, instead of a transmissive type of sensor which is employed in the present embodiment.

Returning to FIG. 2, to explain the connection between the apparatuses, the head measurement apparatus 1 and the strobe camera 2 are connected by means of a USB cable 74. Furthermore, the strobe camera 2 and the data processing apparatus 3 are connected by means of a USB cable 75. The data processing apparatus 3 and the moving image camera 4 are connected by means of a USB cable 76 and the data processing apparatus 3 and the high-speed stereo camera 6 are connected by means of a USB cable 77. The sensor unit 5 and the high-speed stereo camera 6 are connected by a prescribed signal cable 78. The method of connecting the apparatuses may employ a wired or wireless connection method, such as, for example, RS-232C, LAN, Bluetooth (registered trademark), infrared communications, or the like.

In the present embodiment, the head measurement apparatus 1, the strobe camera 2, the data processing apparatus 3, the moving image camera 4, the sensor unit 5 and the high-speed stereo camera 6 are provided separately, but all or a portion of these may be composed an in integrated fashion. For example, it is possible to integrate the head measurement apparatus 1 and the strobe camera 2, or to integrate the data processing apparatus 3 and the moving image camera 4, as in cases where a personal computer forming the data processing apparatus 3 is equipped with a camera which forms the moving image camera 4, for instance.

### [Description of Measurement by Laser Measurement System]

Next, the analysis of the behavior of the club head by a laser measurement system will be described.

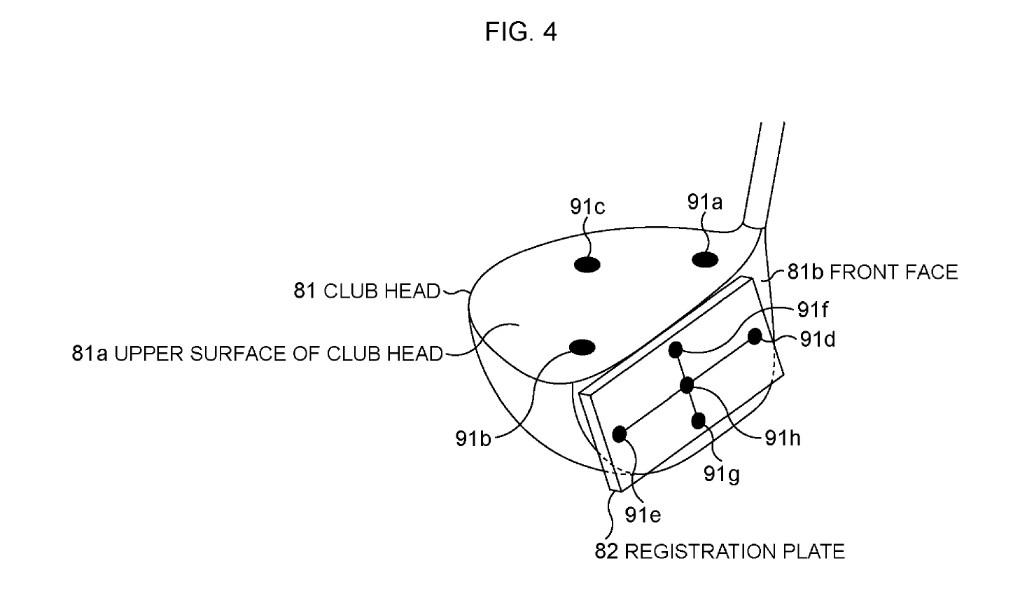

In the analysis of behavior of the club head by the laser measurement system, a registration plate 82 is prepared as shown in FIG. 4. The registration plate 82 is formed by patterning marks 91d to 91h (described below) on a hard plate made of glass, for example.

Before capturing images of the swing action of the player 72, as shown in FIG. 4, the registration plate 82 is attached to the front face 81b of the club head 81 with double-sided tape (not illustrated). Images of the club head 81 and the registration plate 82 are then captured by the high-speed stereo camera 6, with the registration plate 82 in an attached state.

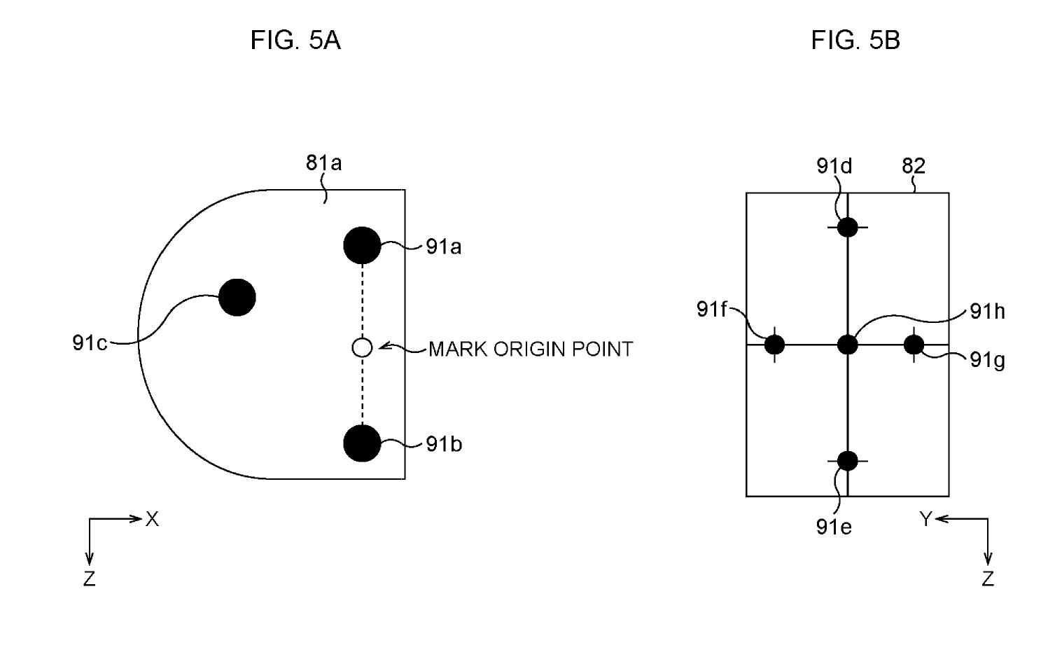

FIG. 5A is an upper surface diagram viewed from the Y direction, showing a front view of the upper surface 81a of the club head in FIG. 4, and FIG. 5B is a front view of the registration plate 82 in FIG. 4, as viewed from the front surface side.

Three markers 91a to 91c are applied to the upper surface 81a of the club head. The markers 91a to 91c can be composed by applying an easily removable sticker, or the like.

On the registration plate 82 which is attached to the front face 81b of the club head 81, a total of five markers 91d to 91h are formed, namely, one in the center of the plate and two situated in symmetrical positions with respect to the center of the plate, on each of the two axial directions which constitute the plane of the plate. More specifically, a marker 91h is formed in the center of the registration plate 82, markers 91e and 91d are formed symmetrically in the Z axis direction with respect to the marker 91h, and the markers 91f and 91g are formed symmetrically in the Y axis direction with respect to the marker 91h. The total of five markers 91d to 91h on the registration plate 82 which corresponds to the front face 81b of the club head 81 are measurement points that are to be measured.

As shown in FIG. 5A, markers 91a and 91b are applied in such a manner that a straight line linking the markers 91a and 91b on the upper surface 81a of the club head is substantially parallel to the Z axis, and the mid-point of the markers 91a and 91b is the point of origin (marker origin point) of all of the markers 91a to 91f.

The right imaging unit 53R and the left imaging unit 53L of the high-speed stereo camera 6 capture images of the club head 81 to which the registration plate 82 has been applied, before capturing images of the club head 81 when swung by the player 72, and the set of captured images obtained as a result of this is supplied to the computation unit 32 of the data processing apparatus 3.

The computation unit 32 of the data processing apparatus 3 calculates three-dimensional coordinates values of the markers 91a to 91h based on the marker origin point, using the principles of triangulation, from the set of (two) captured images captured by the right imaging unit 53R and the left imaging unit 53L.

As described above, for example, the markers 91a and 91b are applied by the player 72 in such a manner that the straight line linking the markers 91a and 91b on the upper surface of the club head 81a is substantially parallel to the Z axis, but it is difficult to make this straight line completely parallel to the Z axis. The computation unit 32 normalizes the eight markers 91a to 91h with respect to the marker origin point in such a manner that the straight line linking the markers 91a and 91b is parallel to the Z axis (x=0), and the Y coordinates values of the three markers 91a to 91c are zero. More specifically, the computation unit 32 rotates the coordinates values of the markers 91a to 91c in the order of X axis, Y axis and Z axis, using the Formula (1) given below for rotation of the X axis, Formula (2) for the rotation of the Y axis and Formula (3) for rotation of the Z axis. The computation unit 32 rotates the coordinates values of the five remaining markers 91d to 91h in accordance with the rotation of the markers 91a to 91c.

$$\begin{matrix}[ Expression 1 ] & \\ [ {x}^{′} , {y}^{′} , {z}^{′} ] = [ x , y , z ] ( \begin{matrix}1 & 0 & 0 \\ 0 & cos θ & sin θ \\ 0 & - sin θ & cos θ\end{matrix} ) & ( 1 ) \\ [ {x}^{′} , {y}^{′} , {z}^{′} ] = [ x , y , z ] ( \begin{matrix}cos θ & 0 & - sin θ \\ 0 & 1 & 0 \\ sin θ & 0 & cos θ\end{matrix} ) & ( 2 ) \\ [ {x}^{′} , {y}^{′} , {z}^{′} ] = [ x , y , z ] ( \begin{matrix}cos θ & sin θ & 0 \\ - sin θ & cos θ & 0 \\ 0 & 0 & 1\end{matrix} ) & ( 3 )\end{matrix}$$

The right-hand term [x,y,z] in Formula (1) to Formula (3) represents a coordinates value before conversion, and the left-hand term [x′,y′,z′] represents a coordinates value after conversion.

The computation unit 32 of the data processing apparatus 3 calculates the relative angle of the front face 81b as viewed from the markers 91a to 91c on the upper surface 81a of the club head (called the relative face angle below), and the central position of the face, from the coordinates values of the markers 91d to 91f of the registration plate 82 after normalization, and stores the results in the storage unit 35. The relative face angle can be determined in the horizontal direction from a straight line linking the coordinates values of the markers 91d and 91e after normalization, in the horizontal direction, and can be determined in the vertical direction from a straight line linking the coordinates values of the markers 91f and 91g after normalization. The central position of the face is the coordinates value of the marker 91h after normalization.

As described above, by capturing an image of the registration plate 82 attached to the front face 81b of the club head 81, before capturing images of the swing action of the player 72, the relative positions of the marks 91a to 91c on the upper surface 81a of the club head, and the marks 91d to 91h on the registration plate 82 corresponding to the front face 81b, are registered. By this means, by capturing the movement of the three markers 91a to 91c on the upper surface 81a of the club head during image capture of the swing action of the player 72, it is possible to capture the behavior of the front face 81b of the club head 81. In this way, by using a registration plate 82, it is possible to register (store) the relative positions of the front face 81b of the golf club 80 and the three markers 91a to 91c on the upper surface 81a of the club head, in cases where, for instance, measurement is made after replacing (changing) the golf club 80, or where a player measures his or her own golf club 80.

### [Club Head Behavior Measurement Items]

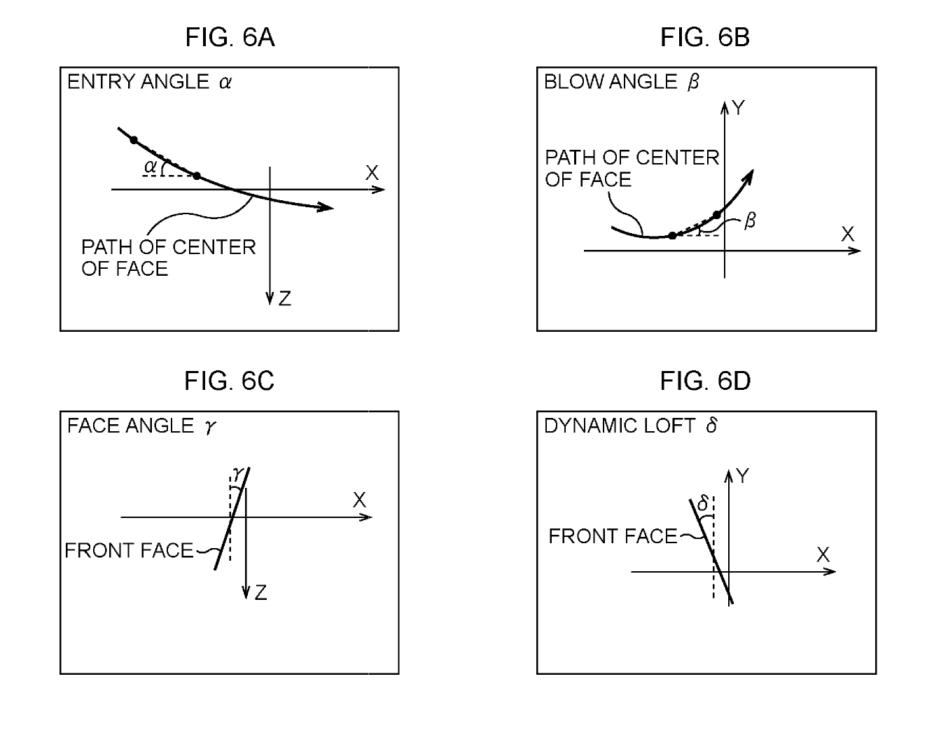

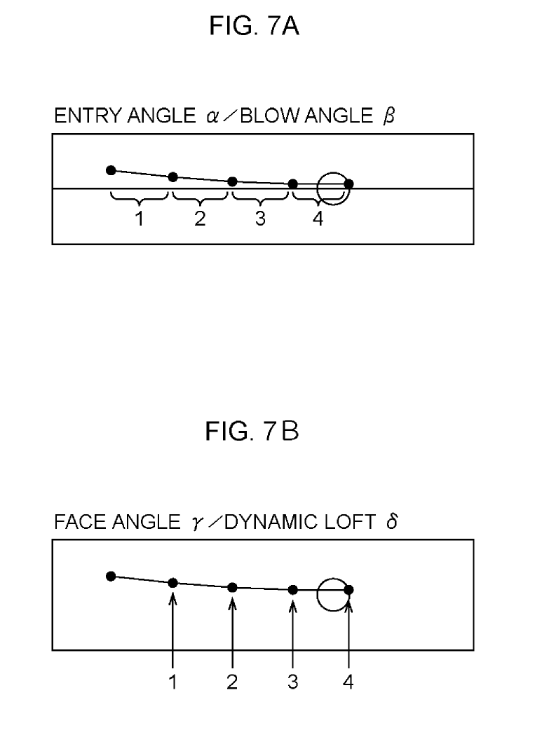

The items which are measured in order to confirm the behavior of the front face 81b of the club head 81 are now described with reference to FIGS. 6A to 6D and FIGS. 7A and 7B.

The computation unit 32 of the data processing apparatus 3 calculates the entry angle α, the blow angle β, the face angle γ, and the dynamic loft δ of the club head 81, from the five sets of captured images obtained by the high-speed stereo camera 6.

FIG. 6A shows a method of calculating the entry angle α of the club head 81.

The entry angle α of the club head 81 is determined by the angle between the X axis and the straight line which links the z coordinate values of the face center positions of the club head 81 obtained from two sets of captured images which are adjacent time-wise of the five sets of captured images (prior and subsequent images).

FIG. 6B shows a method of calculating the blow angle β of the club head 81.

The blow angle β of the club head 81 is determined by the angle between the X axis and the straight line which links the y coordinate values of the face center positions of the club head 81 obtained from two sets of captured images which are adjacent time-wise of the five sets of captured images (prior and subsequent images).

As shown in FIG. 7A, one result for the entry angle α and the blow angle β is obtained from two sets of captured images, namely, a prior and subsequent image, and therefore four results are obtained from the five sets of captured images.

FIG. 6C shows a method of calculating the face angle γ of the club head 81.

The face angle γ of the club head 81 is determined by the angle formed between the YZ plane and a straight line which links the markers 91d and 91e of the front face 81b of the club head 81 as obtained from each of the five sets of captured images.

FIG. 6D shows a method of calculating the dynamic loft δ of the club head 81.

The dynamic loft δ of the club head 81 is determined by the angle formed between the YZ plane and a straight line which links the markers 91f and 91g of the front face 81b of the club head 81 as obtained from each of the five sets of captured images.

One result for the face angle γ and the dynamic loft δ can be obtained from one set of captured images, and therefore it is possible to obtain a total of five results from the five sets of captured images, but in order to align the number of results displayed with the entry angle α and the blow angle β, the data processing apparatus 3 shows four results obtained from four sets of captured images, from the second to fifth sets, as shown in FIG. 7B.

The entry angle α, the blow angle β, the face angle γ and the dynamic loft δ may also be called by different terms, and therefore the titles of the measurement items are not limited to those presented in the present invention. For instance, the dynamic loft may be called the impact loft and the entry angle made be called the head path, or the like. However, whatever the terms used, provided that they are calculated by a method of calculation similar to that described above, then they refer to the same measurement items.

Furthermore, in the computation unit 32 of the data processing apparatus 3, it is also possible to add other items, apart from the entry angle α, the blow angle β, the face angle γ, and the dynamic loft δ described above, as the items which are calculated from the five sets of captured images. For example, the computation unit 32 may also calculate a strike point on the front face 81b of the club head 81, or the like.

### [Example of Measurement Result Display Screen]

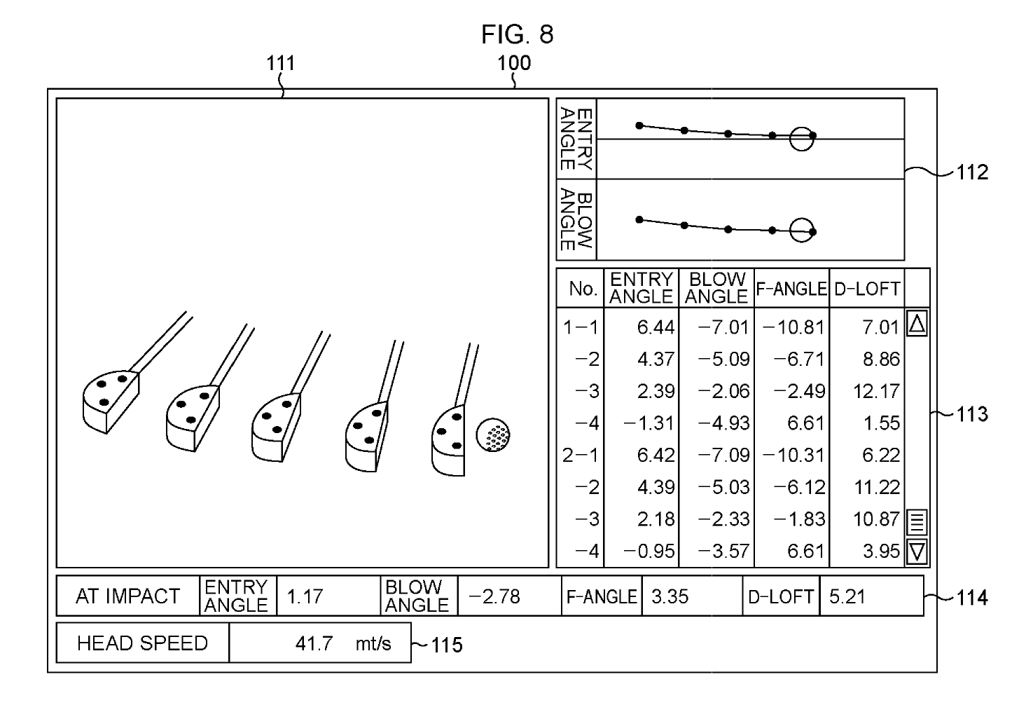

FIG. 8 shows an example of a measurement result display screen which displays analysis results on the display unit 34 of the data processing apparatus 3, based on measurement by the laser measurement system.

The measurement result display screen 100 shown in FIG. 8 is constituted by a captured image display section 111, an angle display section 112, a detailed measurement value display section 113, an impact measurement value display section 114 and a head speed display section 115.

The five sets of captured images captured by the high-speed stereo camera 6 are mutually superimposed and displayed as one image in the captured image display section 111.

The angle display section 112 shows curve graphs depicting the history of the z coordinate value and the y coordinate value which form the basis of the measurement values of the entry angle α and the blow angle β. The angle display section 112 may also display curve graphs depicting the history of the measurement values of the face angle γ and the dynamic loft δ, and may display all four measurement values.

The detailed measurement value display section 113 displays details of four time series data which are calculated from the five sets of captured images obtained in one measurement operation, in respect of each of the calculation items: the entry angle α, the blow angle β, the face angle γ and the dynamic loft δ. The detailed measurement value display section 113 shows a list of all of the calculation results, including the newest calculation results, until the data processing apparatus 3 is switched off (the data processing software terminates).

The impact measurement value display section 114 displays calculation results of predictive calculations for the entry angle α at impact, the blow angle β, the face angle γ, and the dynamic loft δ, in relation to the newest measurement operation (five sets of captured images).

In other words, in the laser measurement system, image capture is carried out by setting a delay time T1 until the start of the first image capturing action (first set of images) on the basis of the head speed measured from the first and second detection signals obtained by the sensor unit 5, in such a manner that the fifth image capturing action desirably comes at the moment of impact, but it is difficult to make this timing coincide completely with the moment of impact.

However, in general, what the player wishes to see as measurement results are the measurement values at the time of impact. Therefore, the data processing apparatus 3 of the laser measurement system makes a predictive calculation of the measurement values at the time of impact, from the four time series data, in respect of each measurement item, namely, the entry angle α, the blow angle β, the face angle γ and the dynamic loft δ.

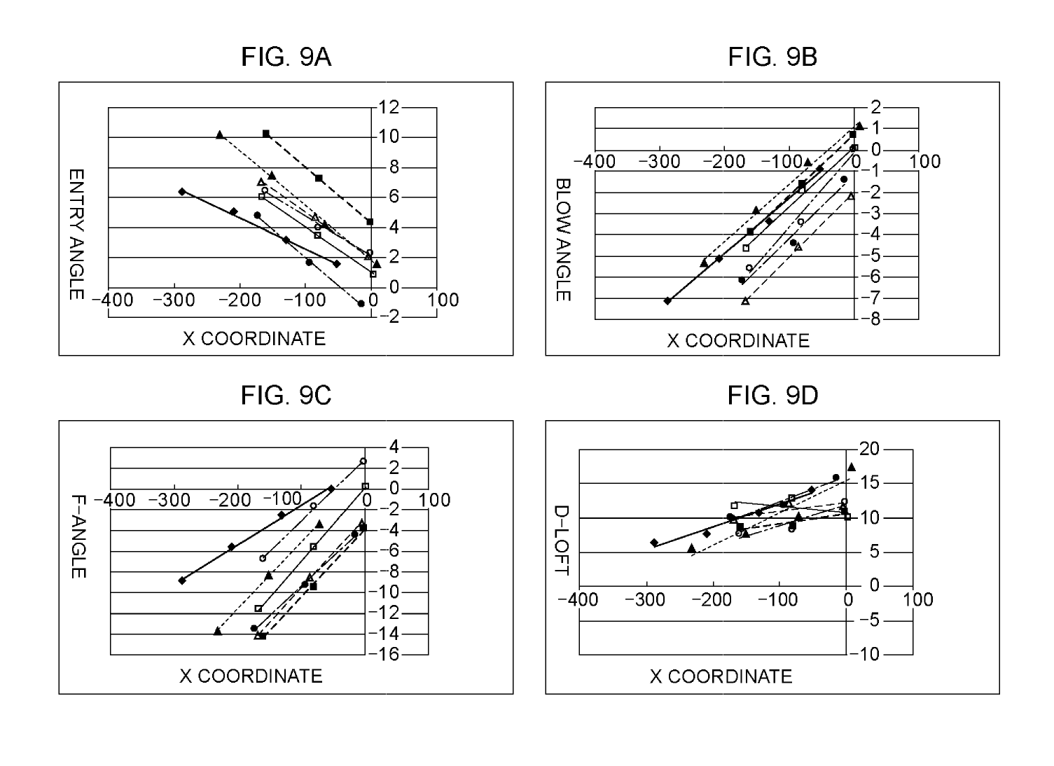

FIGS. 9A to 9D are graphs showing results of calculating four time series data for the entry angle α, the blow angle β, the face angle γ and the dynamic loft δ, as determined from the five sets of captured images obtained in one measurement operation, in relation to a plurality of players.

FIG. 9A shows time series data for the entry angle α, FIG. 9B shows time series data for the blow angle β, FIG. 9C shows time series data for the face angle γ, and FIG. 9D shows time series data for the dynamic loft δ. In FIGS. 9A to 9D, four image capturing actions are performed for each player in one measurement operation, and three time series data are calculated from the four sets of captured images.

As shown in FIGS. 9A to 9D, it can be seen that, in a short time period covering the five (or four) image capturing actions, the measurement values of the entry angle α, the blow angle β, the face angle γ and the dynamic loft δ each change linearly at a uniform gradient.

Therefore, the computation unit 32 of the data processing apparatus 3 makes a predictive calculation of the measurement values at the time of impact, in other words, when the x coordinate value is zero (x=0), by determining an approximation equation which approximates the four (or three) time series data to a straight line, in respect of each of the entry angle α, the blow angle β, the face angle γ and the dynamic loft δ.

The impact measurement value display section 114 in FIG. 8 shows the predictive calculation values for the entry angle α, the blow angle β, the face angle γ and the dynamic loft δ at the time of impact, as calculated in the manner described above. In this way, it is possible to display the entry angle α, the blow angle β, the face angle γ and the dynamic loft δ at the time of impact, and therefore the player's (user's) wish to see the data for the time of impact can be satisfied.

A head speed measured by the high-speed stereo camera 6 on the basis of the first and second detection signals obtained by the sensor unit 5 is displayed in the head speed display section 115 which is to the lower side of the impact measurement value display section 114.

### [Preparatory Processing for Head Behavior Measurement]

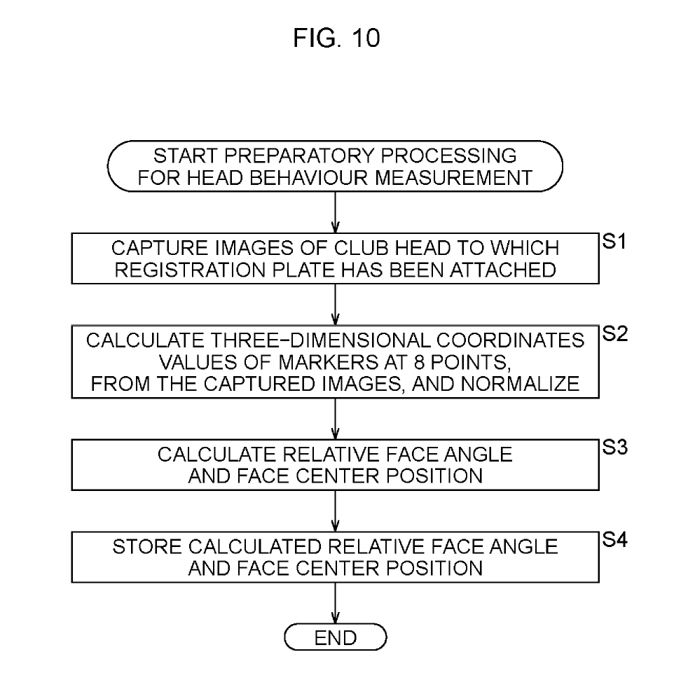

Next, the preparatory processing for head behavior calculation which is carried out in order to measure the behavior of the club head by the laser measurement system will be described with reference to the flowchart in FIG. 10.

In this processing, firstly, in step S1, the high-speed stereo camera 6 captures an image of the club head 81, which bears a registration plate 82 attached to the front face 81b thereof. An imaging command is supplied from the data processing apparatus 3 on the basis of an imaging instruction from the user, for example, and the captured images which are the result of this image capture are supplied from the high-speed stereo camera 6 to the data processing apparatus 3.

In step S2, the computation unit 32 of the data processing apparatus 3 calculates and normalizes the three-dimensional coordinates values of the eight markers 91a to 91h with reference to the marker origin point, from the two captured images (right captured image and left captured image) which are supplied from the high-speed stereo camera 6, as described with reference to FIG. 4 and other drawings.

In step S3, the computation unit 32 calculates the relative face angle, in other words, the relative angle of the front surface 81b as viewed from the markers 91a to 91c on the upper surface 81a of the club head, and the face center position, from the coordinates values of the markers 91d to 91h of the registration plate 82 after normalization.

In step S4, the computation unit 32 stores the relative face angle and the face center position thus calculated, in the storage unit 35, and then terminates processing.

### [Head Behavior Measurement Processing]

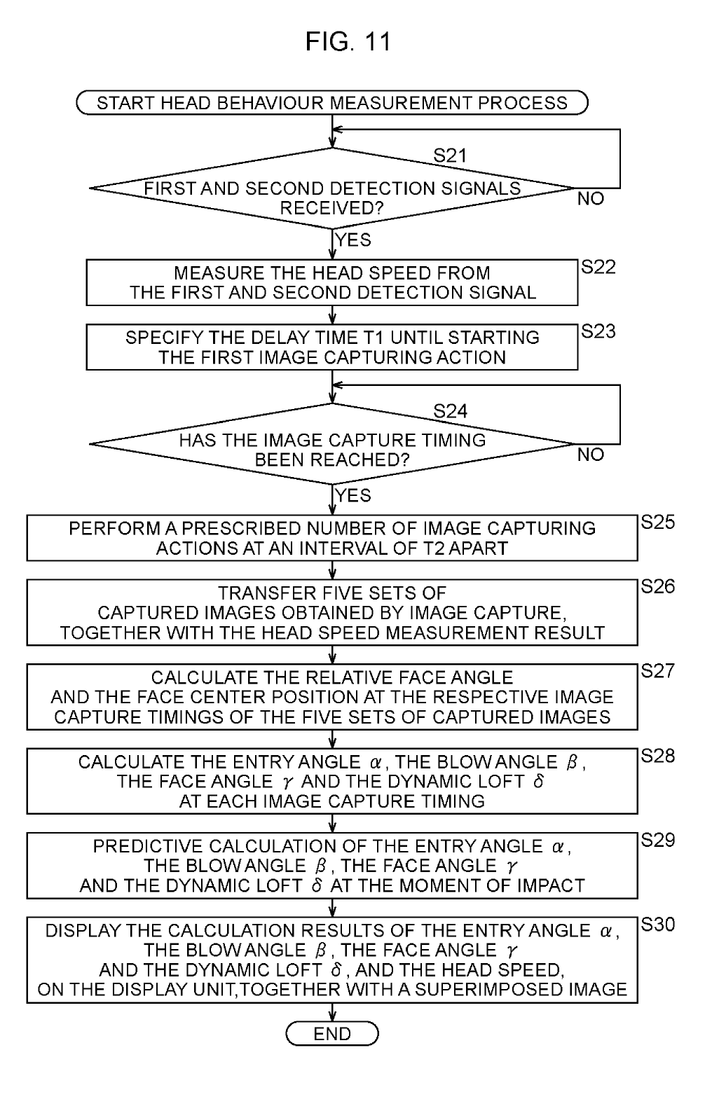

Next, the head behavior measurement processing for measuring the behavior of the club head by the laser measurement system will be described with reference to the flowchart in FIG. 11. Before carrying out this processing, it is necessary for the preparatory processing for head behavior measurement in FIG. 10 to have been completed, and for the relative face angle and the face center position of the club head 81 of the golf club 80 which is swung by the player to have been stored in the data processing apparatus 3.

Initially, in step S21, the control unit 52 of the high-speed stereo camera 6 judges whether or not first and second detection signals have been received from the sensor unit 5, via the communications unit 51, and waits until making a judgment that these signals have been received.

As described with reference to FIG. 3, when the club head 81 shields the laser light from the light emitting unit 41a, the first detection signal is supplied from the sensor unit 5 to the high-speed stereo camera 6, and when the club head 81 shields the laser light from the light emitting unit 41b, the second detection signal is supplied from the sensor unit 5 to the high-speed stereo camera 6.

In step S21, when it has been judged that the first and second detection signals have been received, then the processing advances to step S22, and the control unit 52 of the high-speed stereo camera 6 measures the head speed of the club head 81 on the basis of the first and second detection signals. More specifically, the control unit 52 measures the head speed from the time difference between the times at which the first detection signal and the second detection signal are supplied.

In step S23, the control unit 52 specifies the delay time T1 from the time of reception of the second detection signal, until the start of the first image capturing action, on the basis of the measured head speed.

Thereupon, in step S24, the control unit 52 judges whether the delay time T1 has elapsed, in other words, whether the image capture timing has been reached.

The processing waits at standby until it is judged in step S24 that the image capture timing has been reached, and when it has been judged in step S24 that the image capture timing has been reached, then the processing advances to step S25. In step S25, the high-speed stereo camera 6 performs a prescribed number of image capturing actions (in the present embodiment, five image capturing actions) at intervals of a time period T2 apart. In other words, the control unit 52 of the high-speed stereo camera 6 performs an operation of outputting an imaging command to the right imaging unit 53R and the left imaging unit 53L and also outputting a light emission command to the strobe apparatus 54, five times, at intervals of T2 apart.

In step S26, the control unit 52 transfers the five sets of captured images obtained by image capture, to the data processing apparatus 3, together with the measurement result for the head speed measured in step S21.

In step S27, the computation unit 32 of the data processing apparatus 3 calculates the relative face angle and the face center position of the club head 81 at each capture timing of the five sets of captured images, on the basis of the three markers 91a to 91c on the upper surface 81a of the club head which are depicted respectively in the five sets of captured images supplied from the high-speed stereo camera 6.

In step S28, the computation unit 32 calculates the entry angle α, the blow angle β, the face angle γ and the dynamic loft δ at each image capture timing, from the second to fifth image capture timings, on the basis of the relative face angle and the face center position of the club head 81 determined from each of the five sets of captured images.

In step S29, the computation unit 32 makes a predictive calculation of the entry angle α, the blow angle β, the face angle γ and the dynamic loft δ at the moment of impact. The values of the entry angle α, the blow angle β, the face angle γ and the dynamic loft δ thus determined, and the calculation result for the head speed, are supplied to the display control unit 33, together with a superimposed image in which the five sets of captured images are mutually superimposed.

In step S30, the display control unit 33 causes the display unit 34 to display the measurement result display screen 100 shown in FIG. 8. In other words, the display control unit 33 causes the display unit 34 to display the calculation results for the entry angle α, the blow angle β, the face angle γ and the dynamic loft δ, and the head speed, together with the superimposed image.

With this, the head behavior measurement processing is completed.

According to the laser measurement system described above, firstly, preparatory processing for head behavior measurement is carried out, and the relative face angle and face center position of the club head 81, which represent the positional relationship between the three markers 91a to 91c arranged on the upper surface 81a of the club head, and the face of the club head 81, are stored in the storage unit 35.

Thereupon, when the golf club 80 is swung, the high-speed stereo camera 6 performs a prescribed number of image capturing actions (for example, five image capturing actions) close to the moment of impact. The previously stored positional relationship between the three markers 91a to 91c and the face of the club head 81 is then used to measure (calculate) the behavior of the face of the club head 81 when swung by the player 72, in other words, the entry angle α, the blow angle β, the face angle γ and the dynamic loft δ, on the basis of positions of the three markers 91a to 91c on the upper surface 81a of the club head which are included in the five sets of captured images obtained by image capture.

The markers 91a to 91c on the upper surface 81a of the club head can be composed by attaching an easily removable sticker, or the like. The positions at which the markers 91a to 91c are applied do not have to be aligned strictly on the axes of the coordinates system, as in the prior art, for example, but the three markers 91a to 91c should form a flat plane.

Furthermore, the registration plate 82 is simply attached to the front face 81b of the club head 81 by double-side tape, or the like. Consequently, the accurate positional relationship between the markers 91a to 91c on the upper surface 81a of the club head and the front face 81b can be measured and recorded in a simple manner. Furthermore, when images of the swing of the player 72 are captured, the registration plate 82 is removed, and hence no markings are present which are liable to affect the swing of the player 72.

Consequently, with the laser measurement system, it is possible to measure the behavior of the club head accurately, by means of a simpler composition.

### [Modification Examples of Laser Measurement System]

In the laser measurement system described above, the imaging unit that registers the positional relationship of the three markers 91a to 91c arranged on the upper surface 81a of the club head, and the face of the club head 81, and the imaging unit that captures a plurality of images during a swing action by the player 72 are the same (namely, the high-speed stereo camera 6), but these imaging units may also be different. In other words, the imaging unit that captures an image of the club head 81 to which the registration plate 82 has been attached in order to register the positional relationship may be a stereo camera other than the high-speed stereo camera 6.

Furthermore, in the composition of the laser measurement system described above, three markers 91a to 91c were arranged on the upper surface 81a of the club head, but the number of markers arranged on the upper surface 81a of the club head may be four or more. Furthermore, the markers on the registration plate 82 which corresponds to the front face 81b of the club head 81 may by constituted by a marker 91h in the center of the plate and three other markers, making a total of four markers.

Moreover, in the example described above, the golf club 80 is a driver and the three markers 91a to 91c are arranged on the upper surface 81a of the club head which is the crown portion of the club head 81. However, the present invention may also be applied to a golf club having a relatively narrow upper surface 81a of the club head, such as an iron or a wedge. In this case, the locations where the three markers 91a to 91c are arranged may be set such that, for example, two markers are arranged on the upper surface of the club head, and one marker on the hosel. Alternatively, the locations of the markers may be such that one marker is arranged on the upper surface of the club head, one marker on the hosel of the club head, and one marker on the perimeter portion of the face which is distant from the sweet spot. In other words, the three markers 91a to 91c may be arranged at any positions on the club head, provided that they can form a reference plane for calculating the relative face angle and the face center position.

Above, the high-speed stereo camera 6 determines three-dimensional coordinates values of the markers 91a to 91f by performing image capture from two directions, but it is also possible to determine three-dimensional coordinates values of the markers 91a to 91f from multiple-viewpoint images obtained by image capture from three or more directions.

Moreover, in the laser measurement system described above, the registration plate 82 is constituted by a hard plate made of glass, but the registration plate 82 may also be made from a soft material, such as rubber or silicone, which makes tight contact with the front face 81b of the club head 81.

Furthermore, it is also possible to determine the relative positions of the front face 81b of the golf club 80 and the three markers 91a to 91c on the upper surface 81a of the club head, without using a registration plate 82. For example, it is possible to determine the relative positions on the basis of the markers 91a to 91c arranged on the upper surface 81a of the club head, and a score line on the front face 81b of the club head 81, or to attach a marker directly to the front face 81b and to determine the relative positions on the basis of this attached marker and the markers 91a to 91c arranged on the upper surface 81a of the club head, and so on.

In the first embodiment described above, the laser measurement system was constituted by three apparatuses, namely, the data processing apparatus 3, the sensor unit 5 and the high-speed stereo camera 6, but these apparatuses may be integrated so as to constituted a single measurement apparatus.

Furthermore, in the laser measurement system, the head measurement apparatus 1 and the strobe camera 2 carry out processing independently, but depending on requirements, it is also possible to use the signals and data of the head measurement apparatus 1. For instance, in the laser measurement system described above, the moment of impact is predicted on the basis of a detection signal from the sensor unit 5, but in the head measurement apparatus 1, the moment of impact is determined by a sound signal M.

Therefore, the high-speed stereo camera 6 may carry out image capture continuously for a prescribed period of time at intervals of T2 apart, and a plurality of sets of captured images captured by the high-speed stereo camera 6 close to the moment of impact, as detected by the sound signal M in the head measurement apparatus 1, may be set as captured images for measuring the behavior of the club head. In this case, the sensor unit 5 may be omitted.

### [Relationship Between Doppler Sensor 11 and Measurement Range]

Next, the analysis of the state of motion of the golf ball by the Doppler measurement system will be described.

Firstly, the relationship between the two Doppler sensors 11 in the head measurement apparatus 1 and the range of measurement will be described with reference to FIG. 12. Similarly to FIG. 2, FIG. 12 shows an example of a case where the player is right-handed.

The straight line which links the microphone 14 in the head measurement apparatus 1 with the golf ball 71 and the straight line which links the two Doppler sensors 11a and 11b are mutually perpendicular, and the microphone 14 is arranged on the straight line linking the two Doppler sensors 11a and 11b and at a mid-point between the two Doppler sensors 11a and 11b. Therefore, the two Doppler sensors 11a and 11b are arranged in left/right symmetry with respect to the straight line linking the microphone 14 and the golf ball 71.

In the present embodiment, the angle of radiation of microwaves from the respective Doppler sensors 11a and 11b is 80 degrees, for example. As shown in FIG. 12, the Doppler sensor 11a is arranged in such a manner that an 80-degree fan-shaped measurement range is directed in an opposite direction to the direction of flight of the golf ball 71 (towards the rear side of the direction of flight), from the position where the golf ball 71 is situated. On the other hand, the Doppler sensor 11b is arranged in such a manner that an 80-degree fan-shaped measurement range is directed in the same direction as the direction of flight of the ball, from the position where the golf ball 71 is situated.

With a positional relationship of this kind, when the player is right-handed, the golf club is detected in the measurement range of the Doppler sensor 11a up until striking the golf ball 71. On the contrary, when the player is left-handed, the golf club is detected in the measurement range of the Doppler sensor 11b up until striking the golf ball 71. Consequently, the Doppler sensor 11a is a head speed detection sensor for a right-handed player and the Doppler sensor 11b is a head speed detection sensor for a left-handed player.

In the example shown in FIG. 12, the distance between the golf ball 71 and the head measurement apparatus 1 is set to 300 mm, but the distance between the golf ball 71 and the head measurement apparatus 1 is set suitably to between 300 and 600 mm, approximately.

### [Measurement Processing in Impact Measurement Mode]

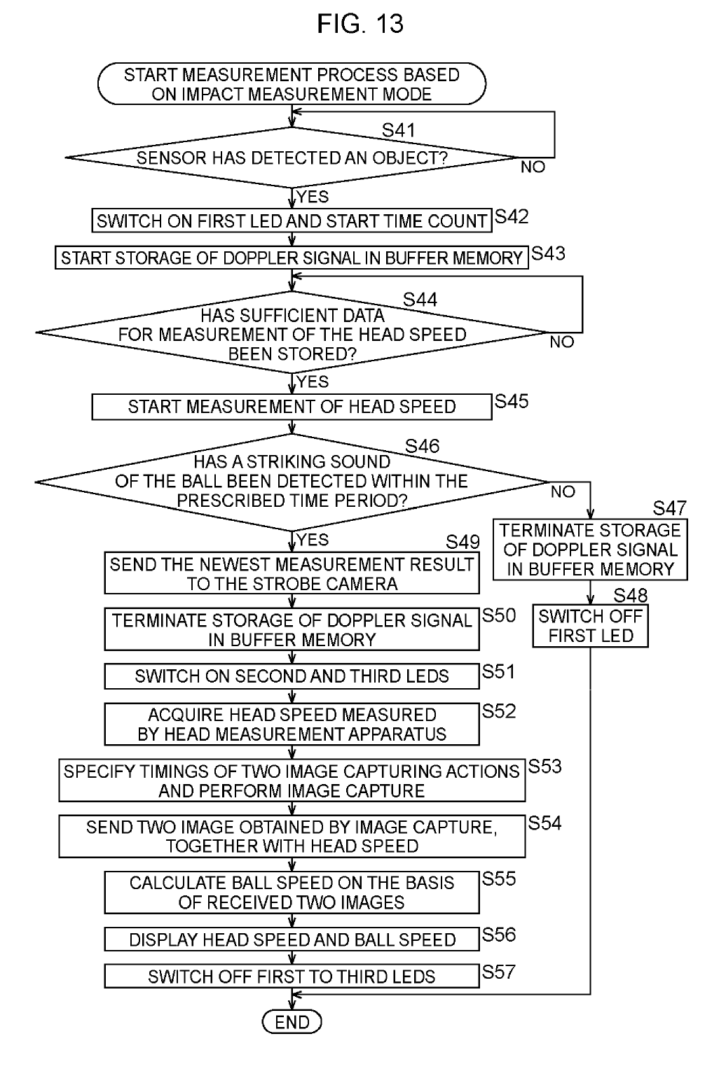

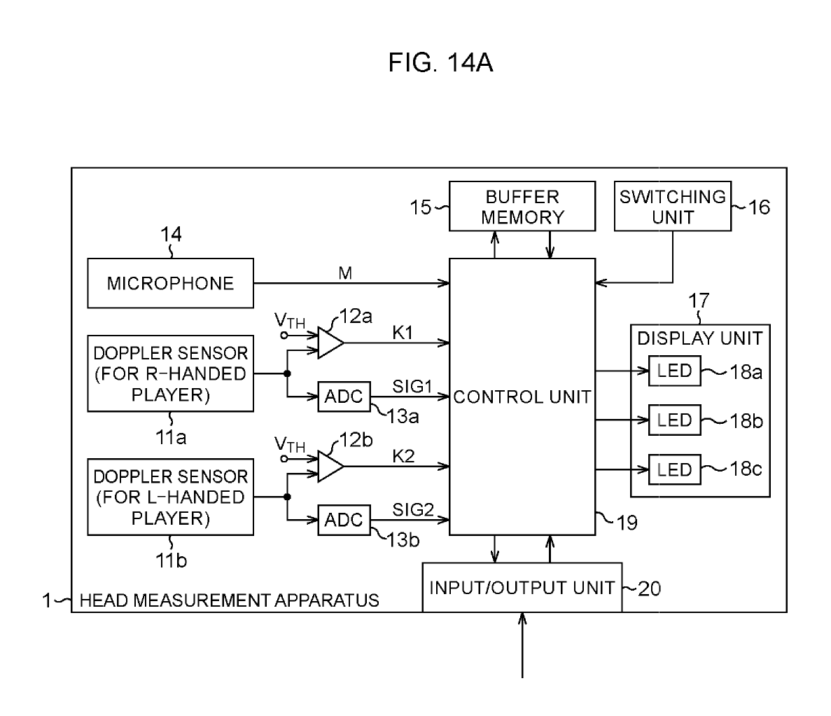

The measurement processing in impact measurement mode is described here with reference to the flowchart in FIG. 13. The operational setup for impact measurement mode is that already carried out before the start of the process. Furthermore, a right-handed setup is made via the switching unit 16 of the head measurement apparatus 1, and the Doppler sensor 11a starts output of microwaves when the power to the head measurement apparatus 1 is switched on.

Firstly, in step S41, the control unit 19 judges whether the Doppler sensor 11a has detected an object, in other words, the club head 81. More specifically, the control unit 19 judges whether or not the Doppler sensor 11a has detected a club head 81 by judging whether or not a detection signal K1 has been supplied from the comparator 12a, and this judgment processing in step S41 is repeated until it is judged that the club head 81 has been detected.

When it has been judged in step S41 that the Doppler sensor 11a has detected the club head 81, then the processing advances to step S42, and the control unit 19 switches on the first LED 18a and starts a time count.

In step S43, the control unit 19 starts storage (writing) of the Doppler signal SIG1 of the Doppler sensor 11a which is digitalized and supplied from the ADC 13a, to the buffer memory 15.

In step S44, the control unit 19 judges whether or not sufficient data (of the Doppler signal SIG1) for measuring the head speed has been stored in the buffer memory 15. In order to accurately measure the head speed, it is necessary to have Doppler signals SIG1 covering a certain time period. In step S44, it is judged whether or not Doppler signals SIG1 of a length corresponding to a previously established prescribed time period for accurately measuring the head speed have been accumulated in the buffer memory 15, and the processing in step S44 is repeated until this data has been accumulated. A time out is set in the processing in step S44, and if a NO judgment continues for a long time at step S44 and a time out has occurred, then the procedure is caused to return to the processing in step S41.

When it is judged in step S44 that data sufficient for measuring the head speed has been stored in the buffer memory 15, then the processing advances to step S45, and the control unit 19 starts measurement of the head speed. From this processing onwards, the head speed is also recalculated (updated) each time a new Doppler signal SIG1 is supplied to the buffer memory 15.

In step S46, the control unit 19 judges whether or not a striking sound of the golf ball 71 has been detected within a prescribed time period after the detection of the club head 81 by the Doppler sensor 11a. More specifically, the control unit 19 judges whether a sound signal M of the club head 81 striking the golf ball 71 has been supplied from the microphone 14, by the time that the count that was started at step S42 has reached a prescribed count number.

In step S46, if it is judged that a striking sound of the golf ball 71 has not been detected within the prescribed time period, then the processing advances to step S47, where the control unit 19 terminates the storage of a Doppler signal from the Doppler sensor 11a in the buffer memory 15, and then in step S48, the control unit 19 switches off the first LED 18a that was switched on and terminates the measurement process.

Consequently, in the measurement process shown in FIG. 13, measurement is not carried out if a striking sound of the golf ball 71 has not been detected within a prescribed time period from the detection of the club head 81 by the Doppler sensor 11a.

On the other hand, in step S46, if it is judged that a striking sound of the golf ball 71 has been detected within a prescribed time period, then the processing advances to step S49, and the control unit 19 sends the newest measurement result for the head speed, to the strobe camera 2, via the input/output unit 20.

Thereupon, in step S50, the control unit 19 terminates the storage of the Doppler signal from the Doppler sensor 11a, in the buffer memory 15, and in step S51, the control unit switches on the second and third LEDs 18b and 18c.

In step S52, the control unit 22 of the strobe camera 2 acquires the head speed measured by the head measurement apparatus 1, via the communications unit 21.

In step S53, the control unit 22 specifies the timings of two image capturing actions to be performed by the imaging unit 23, on the basis of the acquired head speed, and causes the imaging unit 23 to perform image capture on the basis of the specified image capture timing. The strobe apparatus 24 emits strobe light and the imaging unit 23 performs image capture, in accordance with the image capture timing instructed by the control unit 22.

In step S54, the control unit 22 transfers the two images obtained by the two image capturing actions, together with the head speed measured by the head measurement apparatus 1, to the data processing apparatus 3 via the communications unit 21.

In step S55, the computation unit 32 of the data processing apparatus 3 calculates the ball speed on the basis of the two images received from the strobe camera 2. The ball speed thus calculated is supplied to the display control unit 33 together with the head speed which is the measurement result produced by the head measurement apparatus 1.

In step S56, the display control unit 33 causes the display unit 34 to display the head speed and the ball speed supplied from the computation unit 32.

In step S57, after a prescribed time period has elapsed from the output of the head speed, the control unit 19 of the head measurement apparatus 1 switches off the first to third LEDs 18a to 18c, at a suitable prescribed timing when a prescribed time period has elapsed after the display of the head speed and the ball speed, and the control unit 19 then terminates processing.

As described above, in the measurement processing based on the impact measurement mode, the head measurement apparatus 1 measures the head speed continuously until the moment of impact on the basis of Doppler signals for a prescribed period of time, and the moment of impact is also detected on the basis of the sound signal M (the striking sound of the golf ball). The head speed measured immediately before impact is supplied to the strobe camera 2.

In the strobe camera 2, two image capture timings are specified for capturing images of the golf ball 71 immediately after impact, on the basis of the head speed measured by the head measurement apparatus 1, and the strobe camera 2 performs image capture accordingly. Thereupon, in the data processing apparatus 3, the ball speed of the golf ball 71 is calculated on the basis of the two captured images.

In other words, in the Doppler measurement system, rather than measuring both the head speed and the ball speed on the basis of the Doppler signals acquired by one Doppler sensor, as in the prior art, the head speed is measured from the signals of the Doppler sensor 11, and the ball speed is measured from two images captured of the golf ball 71. Consequently, it is possible to more accurately measure the velocities of both the club head 81 and the golf ball 71, which are the states of motion of the striking object and the struck object respectively.

When detecting the moment of impact, if striking of the ball is detected only by using a sound signal, then there may be cases where the system reacts to unrelated noises other than the sound of the golf ball 71 being struck by the club head 81. On the other hand, if the moment of impact is detected by analyzing the Doppler signal, then this information must be determined with high accuracy in a very short time, and therefore a highly expensive processor is required, which is not practicable from a cost viewpoint, and so on. Therefore, in the present embodiment, the moment of impact is identified more accurately than by using only the sound signal, and without requiring an expensive processor, by judging whether or not a striking sound of the golf ball 71 has been detected within a prescribed time period from the time at which the detection signal K1 indicating detection of an object is supplied from the comparator 12a, in other words, from the detection of the club head 81 by the Doppler sensor 11a. In other words, according the Doppler measurement system, it is possible to determine the velocity of the club head 81 and the velocity of the golf ball 71 more accurately, and less expensively.

In conventional measurement of the velocity of the club head and the golf ball, a memory area is reserved for storing the whole time period covering all of the series of swing actions of the player and the flight of the golf ball, and this information is stored accordingly. On the other hand, in this Doppler measurement system, it is possible to accurately identify the moment of impact as described above, and therefore a memory area of the minimum memory capacity required in order to compute the velocities is reserved and information is stored accordingly. Consequently, the memory area required as the buffer memory 15 can be set to the smallest size which enables accurate measurement of the velocity of the club head 81. For example, if measurement data for a period of 0.2 seconds before impact is stored, then a memory region of 16 kByte is sufficient.

### [Modification Examples of Doppler Measurement System]

In the Doppler measurement system described above, a microphone which detects the sound at impact was used as a detection unit that detects the moment of impact, but the invention is not limited to this and may use another detection unit. For example, it is possible to use a line sensor camera as a detection unit that detects the moment of impact, whereby the line sensor camera captures images of the golf ball situated at a prescribed position and the moment of impact is detected as the time at which there has been a change in the captured images, in other words, when the golf ball has disappeared from the captured images. Furthermore, it is also possible to use a transmissive type or reflective type of laser sensor as the detection unit that detects the moment of impact, whereby laser light is irradiated towards the golf ball, and the moment of impact is detected on the basis of the presence or absence of transmitted laser light or the presence or absence of reflected laser light.

Furthermore, in the Doppler measurement system described above, two images for computing the state of motion of the golf ball are captured by one imaging unit 23 in the strobe camera 2, but it is also possible to capture two images by different strobe cameras 2 or different imaging units 23. In other words, there may be two or more strobe cameras 2 or imaging units 23, and the state of motion of the golf ball may be computed using two or more images.

The measurement system in FIGS. 1A and 1B is used, for example, in a sports shop which sells golf clubs, or a golf course where golf lessons are given, or the like.

However, since the head measurement apparatus 1 can be formed as a compact and portable apparatus, then it can also be separated from the strobe camera 2 (and from the data processing apparatus 3 connected to the subsequent stage), and can be used as a portable measurement apparatus which performs speed measurement in impact measurement mode only. If the apparatus is a portable one, then the user (player), for example, can take the apparatus to use it at a golf practice ground, for instance. To make the head measurement apparatus 1 portable, it is necessary to also provide a battery and a 7-segment LED, or the like, for displaying the measured head speed.

However, if the head measurement apparatus 1 is used separately from the strobe camera 2, and the like, then since image capture by the strobe camera 2 is not carried out, it is not possible to measure the ball speed.

Therefore, in the case of measurement by the head measurement apparatus 1 only, the Doppler sensor 11, the comparator 12 and the ADC 13 on the side not used for measuring of the head speed can be employed for measurement of the ball speed.

For example, in a right-handed operational setup, measurement of the ball speed is carried out on the basis of a Doppler signal from the Doppler sensor 11a, but the Doppler sensor 11b is not used. As FIG. 12 reveals, when the player is right-handed, the measurement range of the Doppler sensor 11b includes the trajectory of the golf ball 71 which is projected into flight due to being struck by the golf club 80. Consequently, it is possible to use the Doppler sensor 11b as a sensor for measuring the velocity of the golf ball 71 (ball speed) after being struck by the club head 81 of the golf club 80. The method of measuring the velocity of the golf ball 71 is similar to that for measuring the velocity of the club head 81. However, if a function of this kind is provided in the head measurement apparatus 1, then the buffer memory 15 also needs to have a memory area for use in ball speed measurement.

Moreover, if the head measurement apparatus 1 is provided with a ball speed measurement function based on the unused Doppler sensor 11, then even when the head measurement apparatus 1 is connected to the strobe camera 2, and the like, it is possible to carry out a ball speed measurement process by the unused Doppler sensor 11, and to present both the head speed and the ball speed to the data processing apparatus 3. In this case, the data processing apparatus 3 can compute an average value, or the like, of the ball speed calculated by the computation unit 32 from the two images, and the ball speed measured by the head measurement apparatus 1, and can display this value as the final ball speed. Consequently, the two Doppler sensors 11 which are provided can be used effectively and the measurement accuracy of the ball speed can be improved.

Alternatively, if the head measurement apparatus 1 has a ball speed measurement function and calculates both the head speed and the ball speed and sends these to the data processing apparatus 3, then the computation unit 32 of the data processing apparatus 3 can be made to compute the state of motion of the golf ball apart from the ball speed, such as the number of revolutions of the ball per unit time, for example. In this way, it is possible to make effective use of the ball speed measurement function of the head measurement apparatus 1, and the data processing apparatus 3 can be used for other functions, thus making it possible to utilize the resources of the respective apparatuses in a satisfactory manner.

In the first embodiment which was described above, measurement of the head speed is carried out in both the laser measurement system and the Doppler measurement system. More specifically, in the laser measurement system, the head speed is measured from the time difference when the two laser lights which are separated by a prescribed interval are shielded, and in the Doppler measurement system, the head speed is calculated from the Doppler signals reflected by the club head. These methods of measuring the head speed are interchangeable. In other words, in the laser measurement system, it is also possible to calculate the head speed by using a Doppler sensor, and in the Doppler measurement system, it is also possible to calculate the head speed by using the time difference between the laser light shield timings. Furthermore, in both the laser measurement system and the Doppler measurement system, it is also possible to calculate the head speed by another method.

[Compositional Example of Second Embodiment of Measurement system]

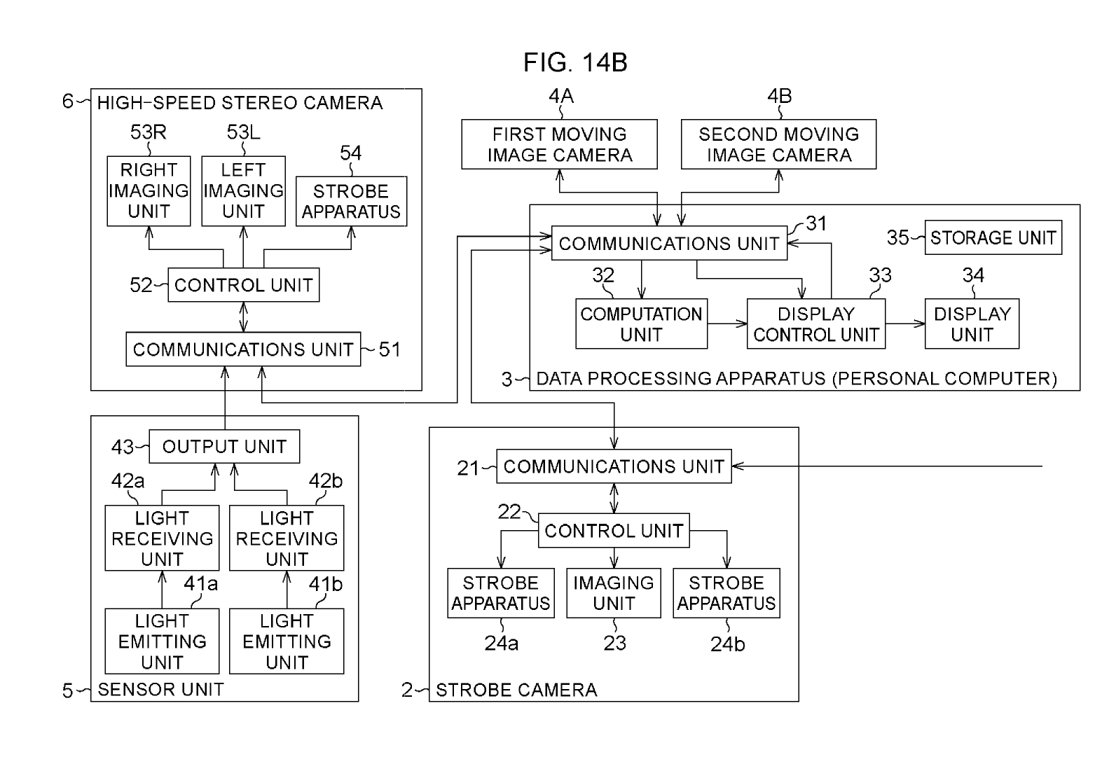

FIGS. 14A and 14B show a compositional example of a second embodiment of a measurement system to which the present invention is applied.

The second embodiment of the measurement system which is shown in FIGS. 14A and 14B differs from the first embodiment described above in that the moving image camera 4, which was provided as one apparatus in the first embodiment, is provided as two apparatuses: a first moving image camera 4A and a second moving image camera 4B.

In the second embodiment of the measurement system, at least one of the processing by the laser measurement system and the processing by the Doppler measurement system described in the first embodiment is carried out in conjunction with swing classification processing for classifying the golf swing of the player 72 and indicating a golf club, and the like, which is optimally suited to the swing of the player 72. Below, only the swing classification processing which is different to that of the first embodiment is described.

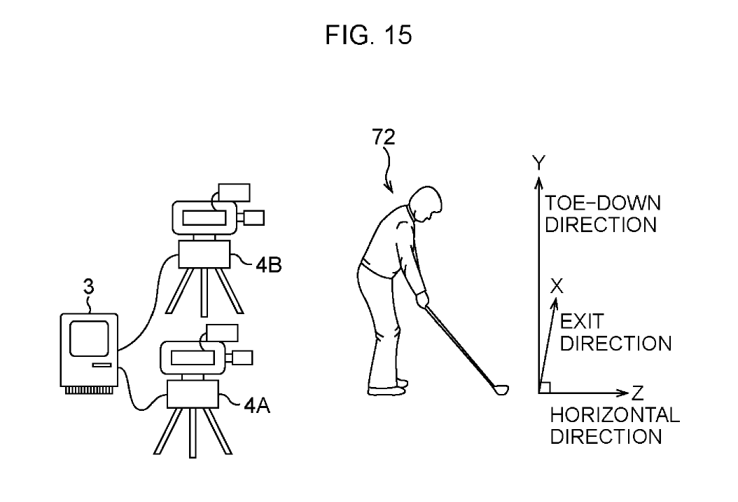

The positional relationship between the first moving image camera 4A and the second moving image camera 4B is now described with reference to FIG. 15.

The first moving image camera 4A and the second moving image camera 4B are arranged to the rear side of the player 72 and capture images (stereo images) of the golf swing of the player 72. The first moving image camera 4A and the second moving image camera 4B may be arranged at a prescribed interval apart so as to be able to acquire video images for measuring the path of the golf swing three-dimensionally. Desirably, the interval between the first moving image camera 4A and the second moving image camera 4B is fixed in such a manner that, after acquiring video images of the golf swing by the first moving image camera 4A and the second moving image camera 4B, the relative positions of the first moving image camera 4A and the second moving image camera 4B can be calculated easily and three-dimensional measurement of the path of the golf swing can be achieved readily.

Furthermore, the first moving image camera 4A and the second moving image camera 4B are arranged at a suitable distance of separation from the player 72 so as to be able to capture images during each stage of the swing of the golf club used by the player 72 (such as the back swing, the down swing and the follow through (described in detail below with reference to FIGS. 18A to 18C)), in order to capture images of the golf swing of the player 72. Here, as described above, desirably, since the interval between the first moving image camera 4A and the second moving image camera 4B is fixed, then even if the first moving image camera 4A and the second moving image camera 4B are adjusted to a suitable interval with respect to the player 72, in accordance with the height and physique of the player 72, and the like, then it is still possible to compare swing paths which are measured in the same plane. This is because the interval between the first moving image camera 4A and the second moving image camera 4B is fixed and therefore the parallax is uniform and conversion from the camera coordinates system to a global coordinates system can be performed easily.

In FIG. 15, the central position of the golf ball which is struck by the player 72 (called the “golf ball position” below) is taken as the point of origin. The axis of the toe-down direction, which passes through the point of origin and is perpendicular to the horizontal plane is called the Y axis. In the present specification, the toe-down direction means a vertical direction. Moreover, the axis which extends in the horizontal plane passing through the point of origin, and which is perpendicular to a line linking both shoulders of the player 72 is called the Z axis. Moreover, the axis which is perpendicular to the Z axis and the Y axis is called the X axis. The X axis direction is also called the “exit direction”, because it corresponds approximately to the direction in which the ball flies off as a result of the golf swing.

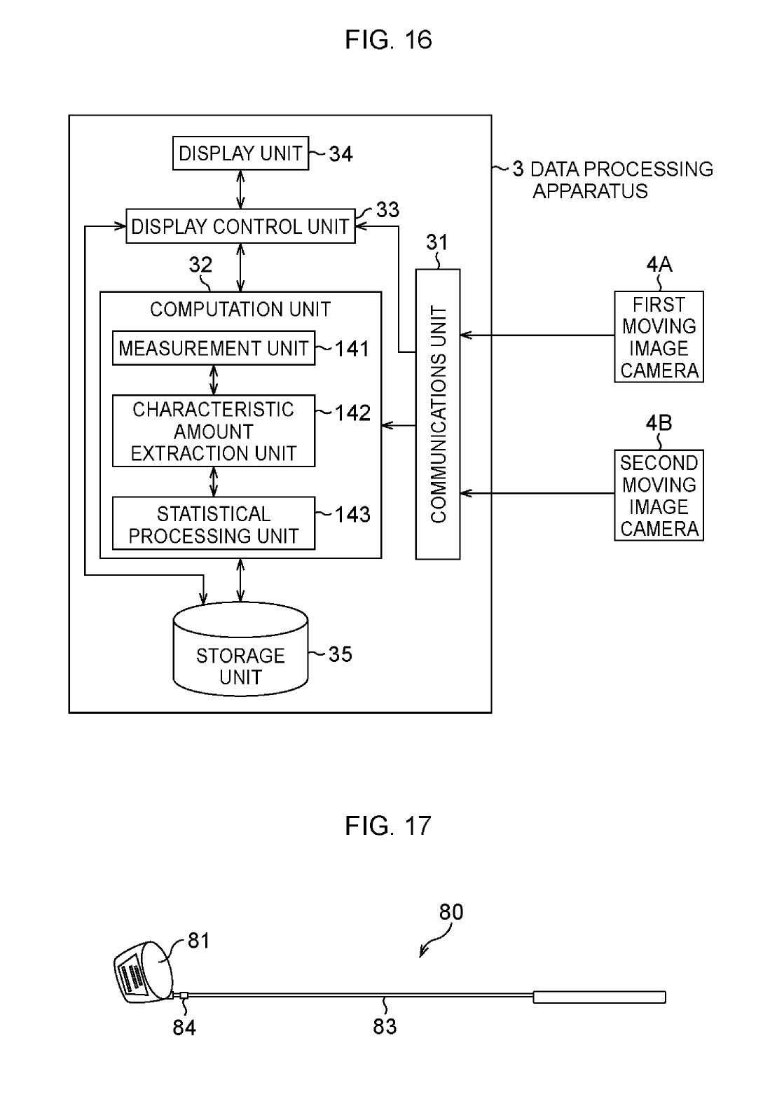

FIG. 16 is a functional block diagram showing an approximate composition of the data processing apparatus 3 according to the second embodiment.

The data processing apparatus 3 includes a computation unit 32 which acquires data about the moving images during the golf swing which constitutes the swing data, from the first moving image camera 4A and the second moving image camera 4B, via the communications unit 31, and carries out computation, a display control unit 33 which controls the whole data processing apparatus 3, a display unit 34 which displays the computation results of the computation unit 32 and the moving images acquired from the first moving image camera 4A and the second moving image camera 4B, and a storage unit 35 which stores computation results from the computation unit 32. The computation unit 32 also comprises a measurement unit 141, a characteristic amount extraction unit 142 and a statistical processing unit 143.

The measurement unit 141 divides the golf swing of the player 72 of which images have been captured by the first moving image camera 4A and the second moving image camera 4B, into a back swing, a down swing and a follow through golf swing path, and selects two golf swing paths from among the back swing, the down swing and the follow through. The measurement unit 141 has a function for then assigning a path in two-dimensional coordinates, taking the Y axis and the Z axis as a vertical axis and a horizontal axis, in respect of the two selected golf swing paths, and thereby generating a first path distribution.

Furthermore, the measurement unit 141 divides the golf swing of the player 72 of which images have been captured by the first moving image camera 4A and the second moving image camera 4B, into a back swing, a down swing and a follow through golf swing path, and selects two golf swing paths from among the back swing, the down swing and the follow through. The measurement unit 141 has a function for then assigning a path in two-dimensional coordinates, taking the Y axis and the X axis as a vertical axis and a horizontal axis, in respect of the two selected golf swing paths, and thereby generating a second path distribution.

The characteristic amount extraction unit 142 has a function of calculating the angle formed between the golf swing path and the horizontal axis, in respect of the first path distribution, and calculating the horizontal distance between any two points on the golf swing path, in respect of the second path distribution. The first path distribution is generated in the YZ plane and the second path distribution is generated in the XY plane.

More specifically, the characteristic amount extraction unit 142 calculates the angle formed between the golf swing path and the horizontal axis, for each of the two golf swing paths selected as the first path distribution (in the present example, the down swing and the follow swing). The characteristic amount extraction unit 142 calculates the angular difference which is the value of the difference between the angles relating to each of the two golf swing paths, as a first characteristic amount of the player's golf swing.

Furthermore, the characteristic amount extraction unit 142 calculates the horizontal distance between prescribed two points on the golf swing path, in respect of each of the two golf swing paths selected as the second path distribution (in the present example, the back swing and the down swing). The characteristic amount extraction unit 142 calculates the distance difference which is the value of the difference between the distances relating to each of the two golf swing paths, as a second characteristic amount of the player's golf swing.

The statistical processing unit 143 has a function for generating a two-dimensional map on the basis of the angular difference and the distance difference calculated as characteristic amounts by the characteristic amount extraction unit 142, and classifying the golf swing on the basis of this two-dimensional map.

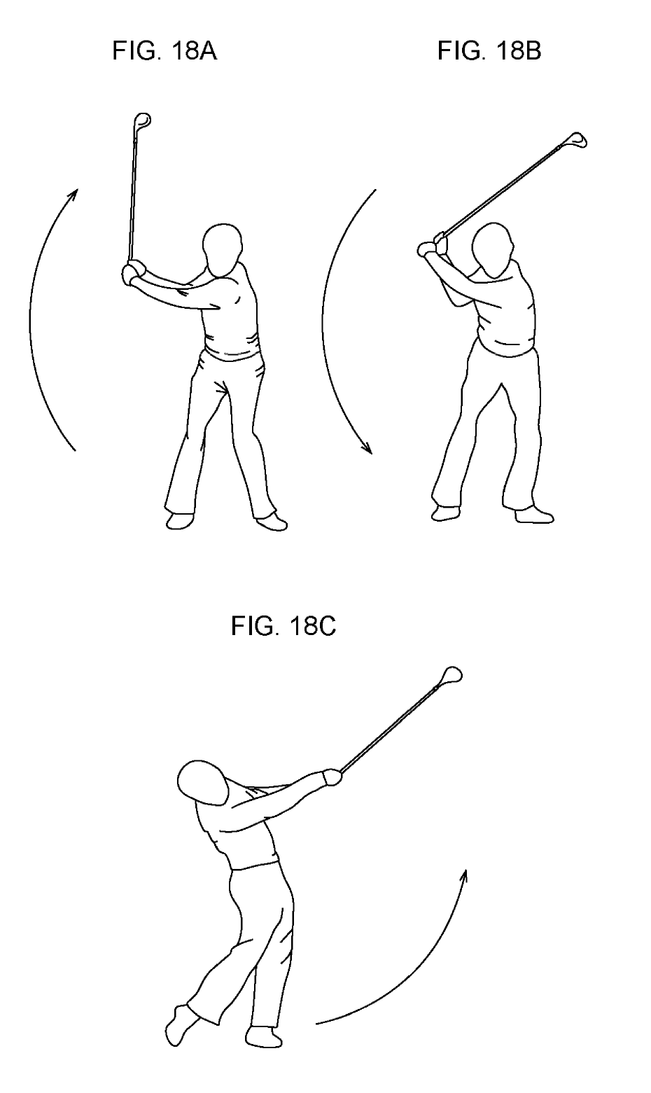

FIG. 17 shows one example of a golf club which is used in the measurement system relating to the second embodiment. The player 72 performs a swing using this golf club 80 (called the “measurement club” below). The first moving image camera 4A and the second moving image camera 4B then capture moving images when the player 72 swings the club. The measurement club 80 has a tracking marker 84 on the shaft 83 in the vicinity of the club head 81, which is the portion that strikes the golf ball. This marker 84 is constituted by attaching a white reflective tape, a spherical marker, a reflective marker, or the like, for example, and by carrying out image capture of the golf swing against a black background, it is possible to track the path of the marker 84 readily by image processing. Furthermore, by attaching the marker 84 in the vicinity of the club head 81, for example, then even in cases where the first moving image camera 4A and the second moving image camera 4B are arranged to the rear side of the player 72, it is possible to shorten the time during which image capture cannot be performed due to the marker 84 being obscured by the player 72.

FIGS. 18A to 18C are diagrams for describing a golf swing. Here, the golf swing is described in terms of three separate stages: a back swing, a down swing and a follow through.

FIG. 18A shows a back swing, which is a stage in which the player 72 swings the measurement club 80 upwards and backwards.

FIG. 18B shows a down swing, which is a stage where the player swings down the measurement club 80, that he or she has swung up by a back swing (FIG. 18A), in order to strike (impact) the golf ball.

FIG. 18C shows a follow through, which is a stage where the player completes the swing of the measurement club 30 after striking the golf ball. After the follow through, the club continues in a state called the “finish”, which is the state at the end of the swing.

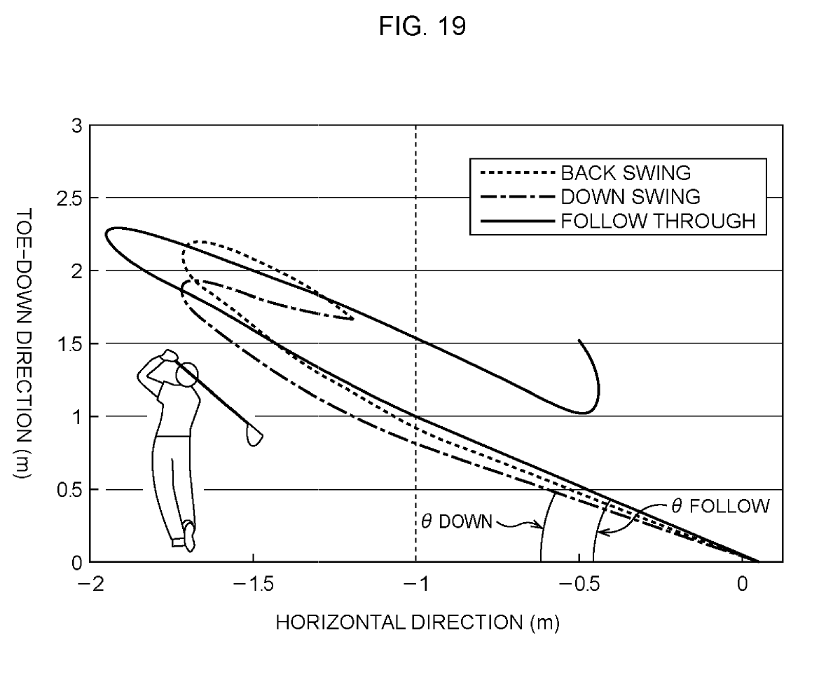

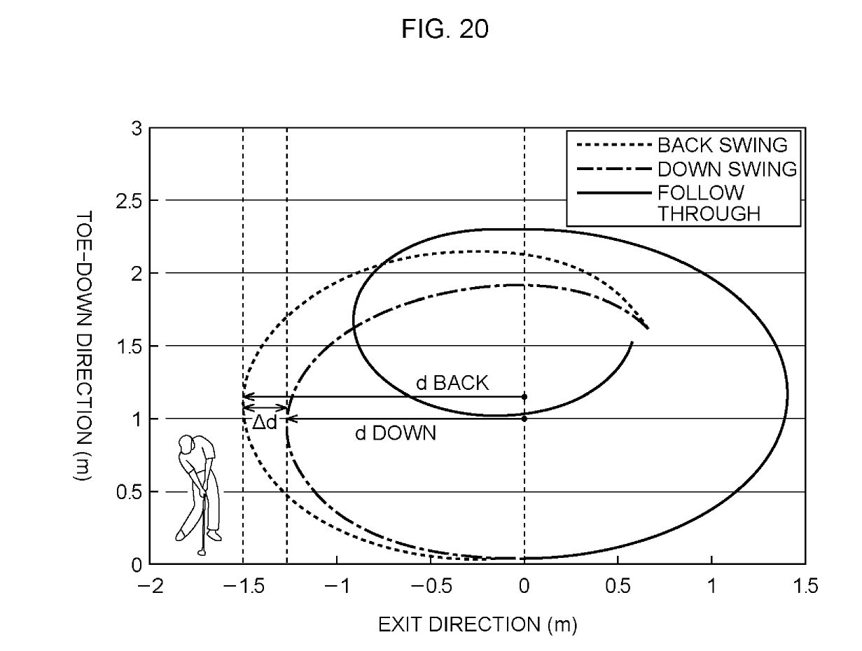

FIG. 19 shows one example of measurement results of the angular difference, which is one characteristic amount. In FIG. 19, the broken line indicates the path of the back swing, the single-dotted line indicates the path of the down swing, and the solid line indicates the path of the follow through. The vertical axis corresponds to the Y axis shown in FIG. 15, and is the position (m) in the height (toe-down) direction when the height of the center position of the golf ball (corresponding to the point of origin shown in FIG. 15, which is called the “impact position” below) is set as 0 m. The horizontal axis corresponds to the Z axis shown in FIG. 15, and indicates a distance from the impact position, when the impact position is set as 0 m, the forward side as viewed from the player 72 who is the subject being indicated by a positive value and the rear side being indicated by a negative value. Consequently, the point of origin of the YZ coordinates system is set to the impact position. The positions of the marker when the player 72 swings the measurement club 80 shown in FIG. 17 are plotted on this two-dimensional coordinates plane, thereby generating a first path distribution. As shown in FIG. 17, in the present embodiment, since the marker 84 is attached to the shaft portion in the vicinity of the head of the measurement club 80, then it is difficult to imagine the marker 84 being in front of the impact position, and hence there is a low possibility of the value on the horizontal axis being a positive value.

The method of extracting the first characteristic amount, which is an indicator for classifying the golf swing path, in the characteristic amount extraction unit 142 of the data processing apparatus 3 will be described below. The present inventors discovered that the difference between the angle formed between the golf swing path of the follow through and the axis in the horizontal direction (Z axis), and the angle formed between the golf swing path of the down swing and the axis in the horizontal direction (Z axis), is an effective indicator for classification purposes. The angle which is formed by the golf swing path of the follow swing or the down swing and the axis of the horizontal direction (Z axis) can be calculated as the angle formed between the axis of the horizontal direction (Z axis) and the straight line linking one point on the golf swing path of the follow swing or the down swing and the impact position (point of origin), for example. In this way, it is possible to exclude the effects of difference in the height of the subject, and the like, by determining the angles formed between the axis of the horizontal direction (Z axis) and straight lines between the origin point and at least two points on the golf swing path, rather than spatial positions on the golf swing path, and by using the angular difference Δθ between the respective angles as an indicator for classification.

In calculating this indicator, firstly, the characteristic amount extraction unit 142 traces a straight line between the impact point, which is the reference point, and a desired point on the follow swing path (for example, a marker position which is distanced approximately −1 m in the horizontal direction (substantially the Z axis direction) from the impact position), calculates the angle formed between the straight line and the ground surface, and sets this value as θ follow. Furthermore, the characteristic amount extraction unit 142 carries out similar calculation in respect of the down swing as well, and the angle thus calculated is set as θ down. The characteristic amount extraction unit 142 calculates the difference between θ follow and θ down (θ follow minus θ down) as the angular difference Δθ. When θ follow is greater than θ down, then the ball tends to perform a hook rotation. Due to this hook rotation, the ball has a leftward curve in the direction of travel of the ball. On the other hand, when θ down is greater than θ follow, then the ball tends to perform a slice rotation. Due to this slice rotation (outer side), the ball has a rightward curve in the direction of travel of the ball.

In this way, it is possible to obtain information that is important for the golfer, based on the relationship between θ down and θ follow. The statistical processing unit 143 sets one or a plurality of threshold values, for example, in respect of the value of the difference between θ down and θ follow (angular difference Δθ), so as to classify the golf swing. In actual practice, by carrying out classification on the basis of one characteristic amount, such as the value of the differential between θ down and θ follow (called “one-dimensional classification” below), it is possible to classify, for example, a golf swing performed by a skilled player and a golf swing performed by an unskilled player. The fixed point is not necessarily the impact position and in FIG. 15, it is also possible to set a point other than the impact point (the center position of the golf ball) as the point of origin, and to carry out the calculation described above with reference to this point.

The example in FIG. 19 uses the value of the differential between θ down and θ follow, as the angular difference Δθ, but similar calculation is also carried out in respect of the back swing, and the calculated angle is set as θ back, the value of the difference between θ down and θ back may be used, or the value of the difference between θ follow and θ back may be used.

Furthermore, in the example in FIG. 19, three golf swing paths, the back swing, the down swing and the follow through, are determined, but it is sufficient to determine two golf swing paths that are necessary for determining the angular difference Δθ, and the calculation of the other one golf swing path is not essential. In the example in FIG. 19, it is possible to omit calculation of the golf swing path of the back swing.

FIG. 20 shows one example of measurement results of the distance difference, which is one characteristic amount. In FIG. 20, similarly to FIG. 19, the broken line indicates the path of the back swing, the single-dotted line indicates the path of the down swing, and the solid line indicates the path of the follow through. The vertical axis in FIG. 20 shows a position in the toe-down direction, similarly to FIG. 19, and the horizontal axis corresponds to the X axis shown in FIG. 15, which corresponds to the exit direction of the golf ball. On the horizontal axis in FIG. 20, the horizontal distance when the impact position is taken as 0 m, is a positive value in the rightward direction and is a negative value in the leftward direction. In striking the golf ball, firstly, the player 72 swings the measurement club 80 upwards and backwards by a back swing, from a position close to the impact position, and then strikes the golf ball at the impact position by performing a down swing and arrives at a finish state by a follow through. FIG. 20 is a diagram showing the path distribution of the marker 84 attached to the measurement club 80 in such a case, as viewed from the Z axis direction shown in FIG. 15.

The method of extracting the second characteristic amount, which is an indicator for classifying the golf swing path, in the characteristic amount extraction unit 142 of the data processing apparatus 3 will be described below. The inventors discovered that the distance difference Δd of the horizontal distance between two prescribed points on the golf swing path is an effective indicator for the classification of a golf swing. In the present embodiment, an example is described in which the difference between the maximum distance in the horizontal direction from the impact position (point of origin) of the back swing path and the maximum distance in the horizontal direction from the impact position (point of origin) of the down swing path is calculated as the distance difference Δd between the distances in the horizontal direction of the prescribed two points on the golf swing path.

More specifically, in FIG. 20, the characteristic amount characteristics unit 142 calculates the maximum distance on the X axis from the impact position on the golf swing path of the back swing, and sets this value as d back. Furthermore, the characteristic amount characteristics unit 142 calculates the maximum distance on the X axis from the impact position on the golf swing path during the down swing, and sets this value as d down. The characteristic amount extraction unit 142 calculates the difference between d back and d down (d back minus d down) as the distance difference Δd. It has been discovered that if the distance difference Δd obtained in this way is large and the down swing path passes significantly to the inner side compared to the back swing path, then the head speed tends to become faster.

In this way, by using the distance difference Δd as an indicator to classify a golf swing, it is possible to exclude the effects of the subject's height, and so on. Therefore, since one-dimensional classification is carried out on the basis of the value of the distance difference Δd, then it is possible to classify, for example, a golf swing performed by a skilled player and a golf swing performed by an unskilled player. The statistical processing unit 143 classifies the golf swing by setting one or a plurality of threshold values, for example, in respect of the distance difference Δd.

The example in FIG. 20 uses a value of the differential between d back and d down as the distance difference Δd, but similar calculation is also carried out in respect of the follow through, the maximum distance thus calculated is set as d follow, and the value of the difference between d follow and d back may be used, or the value of the difference between d follow and d down may be used.

Furthermore, in the example in FIG. 20, three golf swing paths, the back swing, the down swing and the follow through, are determined, but it is sufficient to determine two golf swing paths that are necessary for determining the distance difference Δd, and calculation of the other one golf swing path is not essential. In the example in FIG. 20, it is possible to omit calculation of the golf swing path of the follow through.

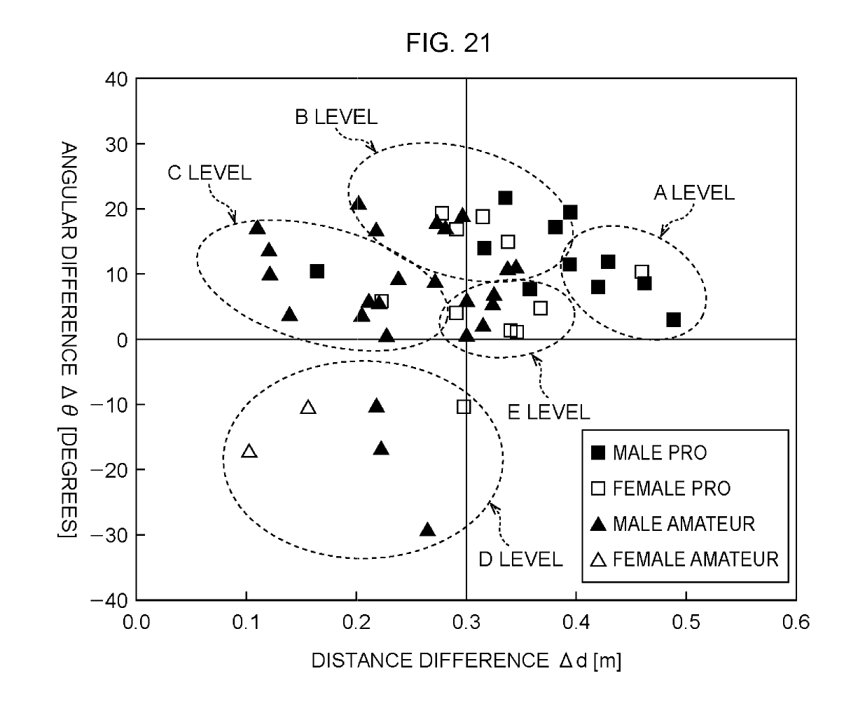

FIG. 21 shows one example of classification results based on the angular difference Δθ which is the difference between θ follow and θ down, and the distance difference Δd, which is the difference between d back and d down. In FIG. 21, the vertical axis indicates the angular difference Δθ which is the characteristic amount described with reference to FIG. 19, and the horizontal axis indicates the distance difference Δd which is the characteristic amount described with reference to FIG. 20. The measurement unit 141 in the data processing apparatus 3 measures the golf swing path in relation to each of a plurality of male professional golfers (male pros), female professional golfers (female pros), male amateurs and female amateurs, and the characteristic amount extraction unit 142 calculates the respective characteristic amounts described above with reference to FIG. 19 and FIG. 20, on the basis of the measurement results. The data of the respective characteristic amounts thus calculated is stored as a database in the storage unit 35 in the data processing apparatus 3. The statistical processing unit 143 in the data processing apparatus 3 plots the characteristic amounts thus obtained, on a two-dimensional plane, and constructs a two-dimensional map in which the two characteristic amounts described above are plotted on the vertical axis and the horizontal axis. Clustering is applied to the two-dimensional map thus constructed, and classification levels from level A to level E are extracted.

In classifying a golf swing, the data processing apparatus 3 calculates the characteristic amounts described in relation to FIG. 19 and FIG. 20, from the golf swing which is the object of measurement, and classifies the golf swing as one of the levels A to E described above, by a shortest distance method, or the like, for example. In this way, it is possible to classify the type of golf swing into distinct levels, based on the characteristic amounts extracted from the golf swing path.

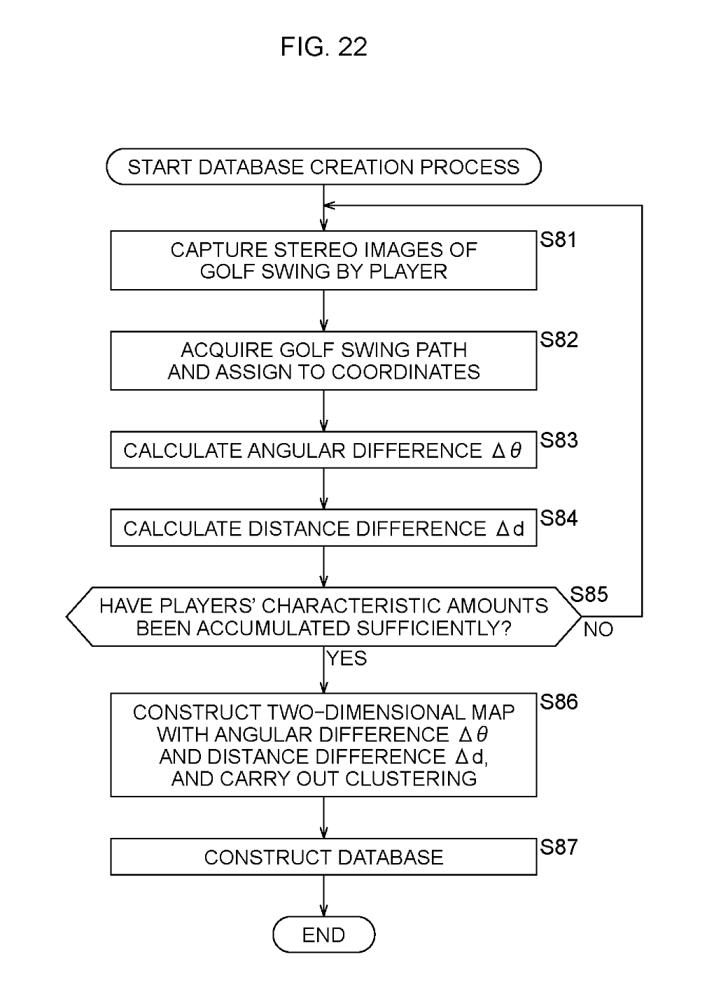

FIG. 22 is a flowchart illustrating database creation processing for creating a database of characteristic amounts for a player 72, based on a second embodiment of the measurement system.

Initially, in step S81, the first moving image camera 4A and the second moving image camera 4B capture stereo images of the golf swing of the player 72.

In step S82, the measurement unit 141 acquires information about the golf swing path of the player 72, from the moving image data captured by the first moving image camera 4A and the second moving image camera 4B, and assigns this information to coordinates. Here, in order to identify and extract the golf swing operation performed by the player 72, from the moving image data captured by the first moving image camera 4A and the second moving image camera 4B, it is possible to use the sound signal M for detecting the moment of impact in the head measurement apparatus 1, or the first detection signal or the second detection signal output by the sensor unit 5. More specifically, the sound signal M is acquired from the head measurement apparatus 1, or the first detection signal or the second detection signal is acquired from the sensor unit 5, and the moving image data of the first moving image camera 4A and the second moving image camera 4B during a prescribed time period from the timing indicated by the acquired signal, can be identified and extracted as data of the golf swing operation performed by the player 72.

In step S83, the characteristic amount extraction unit 142 calculates the angular difference Δθ which is the difference between θ follow and θ down, on the basis of the method described with reference to FIG. 19.

Furthermore, in step S84, the characteristic amount extraction unit 142 calculates the distance difference Δd which is the difference between d back and d down, on the basis of the method described with reference to FIG. 20. The angular difference Δθ and the distance difference Δd which have been calculated in steps S83 and S84 are stored in the storage unit 35.

In step S85, the statistical processing unit 143 judges whether sufficient characteristic amounts for players 72 have been accumulated. In step S85, if it is judged that sufficient characteristic amounts have not been accumulated, then the processing returns to step S81. By this means, further characteristic amounts are gathered in respect of other players 72 and, for example, characteristic amounts for a large number of players 72, such as male and female pros and male and female amateurs, are accumulated in the storage unit 35.

In step S85, when it is judged that sufficient characteristic amounts have been accumulated, the processing advances to step S86, and the statistical processing unit 143 constructs a two-dimensional map using the angular difference Δθ and the distance difference Δd, on the basis of the plurality of data accumulated in the storage unit 35, and carries out clustering.

In step S87, the statistical processing unit 143 stores the classification level extracted by clustering, in the storage unit 35, and constructs a database accordingly. Here, the storage unit 35 associates and saves previously established information about an optimal golf club for each individual, with each of the plurality of players 72 (male and female pros and male and female amateurs, etc.) for which measurement has been performed.

In this way, the functional blocks included in the computation unit 32 perform computations in respect of a prescribed number of data or more, and the computation results are stored in a storage unit 35 to construct a database.

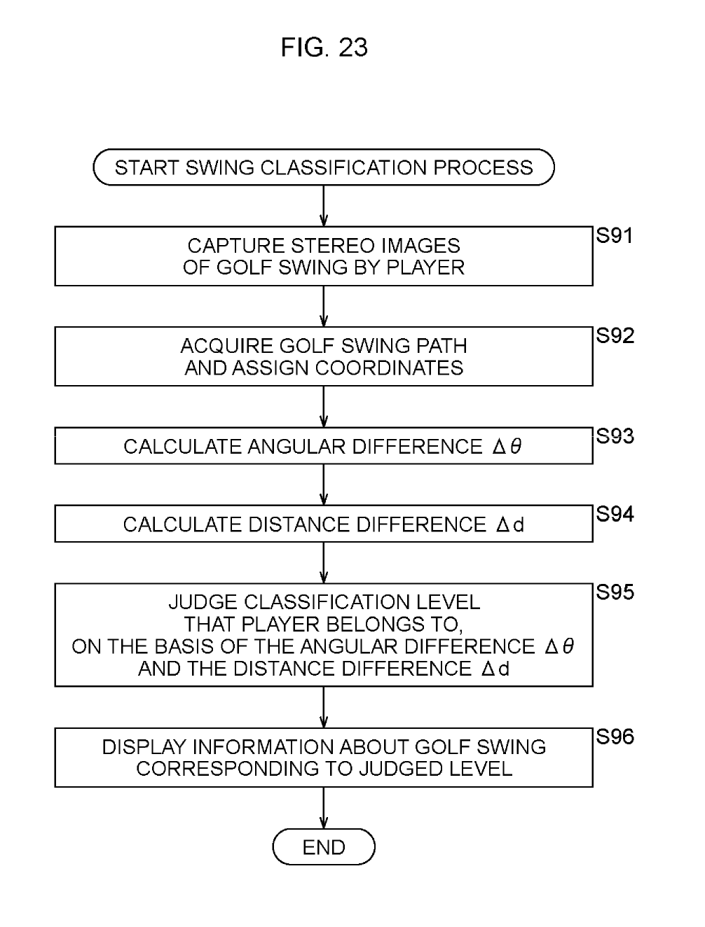

Next, a swing classification process for classifying the golf swing of one subject (player 72) will be described with reference to the flowchart in FIG. 23.

Firstly, in steps S91 to S94, similarly to steps S81 to S84 described above, the functional blocks included in the computation unit 32 calculate respective characteristic amounts for the player 72 who is the subject, in other words, the angular difference Δθ and the distance difference Δd.

In step S95, the statistical processing unit 143 judges the classification level to which the player 72 belongs, on the basis of the angular difference Δθ and the distance difference Δd thus calculated for the player 72. The statistical processing unit 143 uses a shortest distance method, for example, to judge which of the plurality of classification levels stored in the storage unit 35 the player 72 most closely resembles.

In step S96, the display control unit 33 causes the display unit 34 to display information about a golf club 80, which is associated with the plurality of male and female pros and male and female amateurs, and which corresponds to the classification level judged by the statistical processing unit 143.

In this way, according to the second embodiment, the data processing apparatus 3 divides a golf swing of which images have been captured into a back swing, a down swing and a follow through, calculates an angular difference Δθ and a distance difference Δd in respect of any two of these three golf swing paths, and generates a two-dimensional map. The data processing apparatus 3 then classifies the golf swing of the player 72 who is the subject, on the basis of the two-dimensional map thus generated. Therefore, it is possible to classify golf swing paths in a detailed fashion. A candidate golf club which is optimal for the subject can be suggested on the basis of the classification results, and hence one indicator enabling the subject to select an optimal golf club can be presented.

In the second embodiment described above, moving image cameras 4 (a first moving image camera 4A and second moving image camera 4B) are used as an acquisition apparatus for acquiring swing data for calculating the path of the player's golf swing, and this path of the player's golf swing is calculated on the basis of moving image data during the player's golf swing which is obtained by the moving image cameras 4.

However, for example, it is also possible to calculate the path of the player's golf swing by installing an acceleration sensor or gyro sensor on the shaft or hosel of the golf club 80, or the like, and using sensor data when the player swings the club in order to strike (impact) the golf ball. Consequently, it is also possible to use an acceleration sensor or a gyro sensor as an acquisition apparatus for acquiring swing data during the player's golf swing, instead of the moving image cameras used in the second embodiment described above.

Furthermore, in the example described above, a two-dimensional map is created by calculating both the angular difference Δθ and the distance difference Δd as characteristic amounts, but it is also possible to calculate only one of the angular difference Δθ and the distance difference Δd. In this case, the player 72 can be classified depending on which of a plurality of classification levels based on one or more threshold values, the calculated angular difference Δθ or the distance difference Δd belongs to. Furthermore, in this case, it is sufficient to have only one moving image camera 4, and either one of the first moving image camera 4A and the second moving image camera 4B can be omitted, the golf swing path being calculated by using the moving images captured in the with-image measurement mode according to the first embodiment described above. When calculating only one of the angular difference Δθ and the distance difference Δd, the position of the one moving image camera 4 can be set to an optimal position corresponding to the characteristic amount that is to be calculated, for example, to the rear, to the front or to the side of the player 72, in the case of the angular difference Δθ, and to the rear or to the front of the player 72, in the case of the distance difference Δd.

According to the second embodiment, it is possible to classify the golf swings of players 72 (golfers), and on the basis of these respective classification results, it is possible to present information about shafts or golf clubs that are suited to respective players 72.

Furthermore, by also combining the use of head behavior analysis processing by the laser measurement system, it is possible to easily and accurately measure the behavior of the club head during the golf swing by the player 72 (namely, the entry angle α, the blow angle β, the face angle γ and the dynamic loft δ) as well.

Furthermore, when combined with measurement processing by the Doppler measurement system, it is possible to measure both the head speed and the ball speed during the golf swing of the player 72, more accurately.

Embodiments of the present invention have been described here, but it is also possible to add various modifications within the scope of the claims. For example, in the second embodiment described above, stereo image capture is carried out using a first moving image camera 4A and a second moving image camera 4B in order to raise the measurement accuracy, but it is also possible, for example, to arrange the first moving image camera 4A and the second moving image camera 4B to the rear and to the side of the player 72, to carry out normal image capture respectively, and to acquire the golf swing path by two-dimensional measurement.

### [Example of Computer Hardware Composition]

The series of processing described above can be executed by hardware or can be executed by software. If the series of processing is executed by software, then a program constituting this software is installed in a computer. Here, the computer may be a computer incorporated into dedicated hardware, or a general personal computer, for example, which is capable of executing various functions by installing various programs therein.

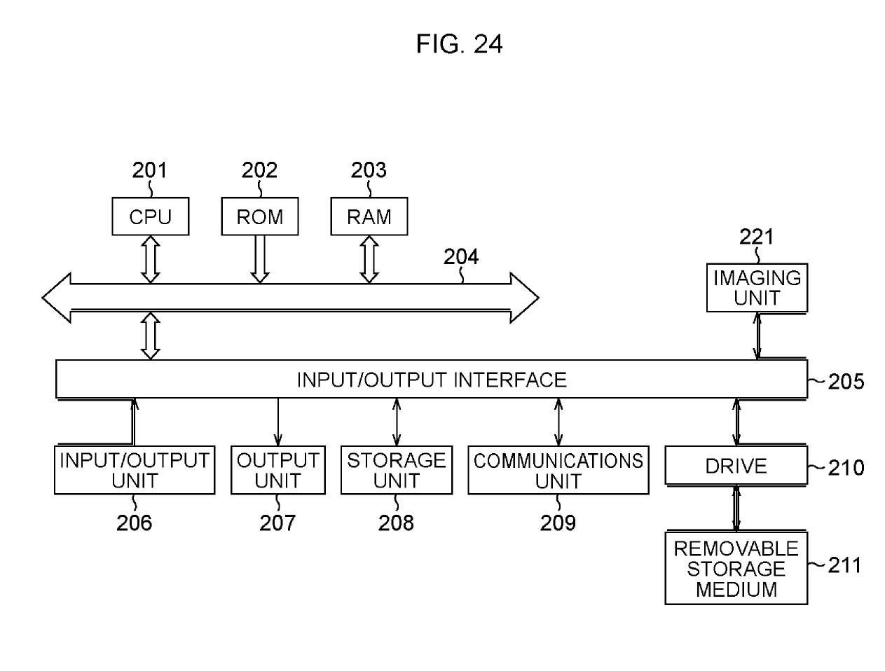

FIG. 24 is a block diagram showing an example of a hardware composition of a computer (personal computer) which executes the series of processing described above on the basis of a program.

In the computer, a central processing unit (CPU) 201, a read only memory (ROM) 202, and a random access memory (RAM) 203 are interconnected via a bus 204.

The bus 204 is also connected to an input/output interface 205. The input/output interface 205 is connected to an input unit 206, an output unit 207, a storage unit 208, a communications unit 209 and a drive 210.

The input unit 206 is constituted by a keyboard, a mouse, a microphone, and the like. The output unit 207 is constituted by a display and a speaker, and the like. The storage unit 208 is constituted by a hard disk or a non-volatile memory, and the like. The communications unit 209 is constituted by a network interface, or the like. The drive 210 drives a removable recording medium 211, such as a magnetic disk, optical disk, magneto-optical disk, or a semiconductor memory.

The imaging unit 221 is constituted by an imaging element, such as a CCD or a CMOS sensor, or the like. The imaging unit 221 captures images of the subject and supplies the captured image data of the subject to the CPU 201, and the like, via the input/output interface 205.

In the computer composed as described above, the CPU 201 carries out the series of processes described above by, for example, loading a program stored in the storage unit 208, into the RAM 203, via the input/output interface 205 and the bus 204, and executing the program.

The program executed by the computer (CPU 201) can be presented, for example, by being recorded on a removable recording medium 211 as a media package. Furthermore, the program can also be presented via a wired or wireless transmission medium, such as a local area network, the Internet, or digital satellite broadcast.

In a computer, the program can be installed in the storage unit 208 via the input/output interface 205, by installing the removable recording medium 211 in the drive 210. Furthermore, the program can also be received by the communications unit 209, via a wired or wireless transmission medium, and then installed in the storage unit 208. Apart from this, the program can also be installed previously in the ROM 202 or the storage unit 208.

The program which is executed by the computer may be a program by which processing is carried out in a time series following the procedure described in the present specification, or may be a program by which processing is carried out in parallel, or at a necessary timing, such as when called up.

In the present specification, the system refers to the whole of the apparatus which is constituted by a plurality of apparatuses.

Furthermore, the embodiment of the present invention is not limited to the embodiments described above and various modifications are possible within a range that does not deviate from the essence of the present invention.

What is claimed is:

1. An analysis system which analyzes a golf swing when a player strikes a golf ball with a golf club, comprising:
a head measurement apparatus which measures a head speed of the golf club when striking the golf ball;
an imaging unit which captures still images used for computing a state of motion of the golf ball on the basis of the head speed measured by the head measurement apparatus;
an acquisition apparatus which acquires swing data, which is data during a golf swing of the player; and
a data processing apparatus which analyzes the golf swing on the basis of the swing data and also computes the state of motion of the golf ball on the basis of the still images captured by the imaging unit,
wherein the data processing apparatus includes:
a measurement unit which divides the golf swing identified by the swing data into golf swing paths of a back swing, a down swing and a follow through, and assigns a path in two-dimensional coordinates having a vertical axis and a horizontal axis, to any two golf swing paths among the back swing, the down swing and the follow through;
a characteristic amount extraction unit which calculates an angle formed between the golf swing path and the horizontal axis, for each of the two golf swing paths; and
a statistical processing unit which classifies the golf swing on the basis of an angular difference between the respective angles thus calculated.

2. An analysis method for an analysis system that includes:
a head measurement apparatus which measures a head speed of a golf club when a player strikes a golf ball with the golf club;
an imaging unit which captures still images on the basis of the head speed measured by the head measurement apparatus;
an acquisition apparatus which acquires swing data, which is data during a golf swing of the player; and
a data processing apparatus which analyzes the golf swing on the basis of the swing data and also computes a state of motion of the golf ball on the basis of the still images captured by the imaging unit,
the analysis method comprising:
a process in which the head measurement apparatus measures the head speed of the player, the imaging unit captures the still images used for computing the state of motion of the golf ball on the basis of the measured head speed, and the data processing apparatus computes the state of motion of the golf ball on the basis of the still images captured by the imaging unit; and
a process in which the acquisition apparatus acquires the swing data; and the data processing apparatus: divides the golf swing identified by the swing data into golf swing paths of a back swing, a down swing and a follow through, and assigns a path in two-dimensional coordinates having a vertical axis and a horizontal axis, to any two golf swing paths among the back swing, the down swing and the follow through; calculates an angle formed between the golf swing path and the horizontal axis, for each of the two golf swing paths; and classifies the golf swing on the basis of an angular difference between the respective angles thus calculated.

3. An analysis system which analyzes a golf swing when a player strikes a golf ball with a golf club, comprising:
an imaging unit which captures a plurality of still images close to a moment of impact when the golf club is swung;
an acquisition apparatus which acquires swing data, which is data during a golf swing of the player; and
a data processing apparatus which analyzes the golf swing on the basis of the swing data and also measures a behavior of a face of a club head of the golf club on the basis of the still images captured by the imaging unit,
wherein the data processing apparatus includes:
a storage unit which stores a positional relationship between at least three markers arranged on the club head of the golf club, and the face of the club head; and
a computation unit which measures the behavior of the face of the club head during a swing on the basis of positions of the markers contained in the captured still images, by using the positional relationship stored in the storage unit, and
the computation unit includes:
a measurement unit which divides the golf swing identified by the swing data into golf swing paths of a back swing, a down swing and a follow through, and assigns a path in two-dimensional coordinates having a vertical axis and a horizontal axis, to any two golf swing paths among the back swing, the down swing and the follow through;
a characteristic amount extraction unit which calculates an angle formed between the golf swing path and the horizontal axis, for each of the two golf swing paths; and
a statistical processing unit which classifies the golf swing on the basis of an angular difference between the respective angles thus calculated.

4. An analysis method for an analysis system that includes:
an imaging unit which captures a plurality of still images close to a moment of impact when a golf club is swung by a player;
an acquisition apparatus which acquires swing data, which is data during a golf swing of the player; and
a data processing apparatus which analyzes the golf swing on the basis of the swing data and also measures a behavior of a face of a club head of the golf club on the basis of the still images captured by the imaging unit,
the analysis method comprising:
a process in which the imaging unit captures a plurality of still images close to the moment of impact when the golf club is swung; and the data processing apparatus measures the behavior of the face of the club head during a swing on the basis of positions of at least three markers arranged on the club head of the golf club and contained in the captured still images, by using a positional relationship between the markers and the face of the club head, this positional relationship being previously stored in a storage unit; and
a process in which the acquisition apparatus acquires the swing data; and the data processing apparatus: divides the golf swing identified by the swing data into golf swing paths of a back swing, a down swing and a follow through, and assigns a path in two-dimensional coordinates having a vertical axis and a horizontal axis, to any two golf swing paths among the back swing, the down swing and the follow through; calculates an angle formed between the golf swing path and the horizontal axis, for each of the two golf swing paths; and classifies the golf swing on the basis of an angular difference between the respective angles thus calculated.

5. An analysis system which analyzes a golf swing when a player strikes a golf ball with a golf club, comprising:
a head measurement apparatus which measures a head speed of the golf club when striking the golf ball;
an imaging unit which captures still images used for computing a state of motion of the golf ball on the basis of the head speed measured by the head measurement apparatus;
an acquisition apparatus which acquires swing data, which is data during a golf swing of the player; and
a data processing apparatus which analyzes the golf swing on the basis of the swing data and also computes the state of motion of the golf ball on the basis of the still images captured by the imaging unit,
wherein the data processing apparatus includes:
a measurement unit which divides the golf swing identified by the swing data into golf swing paths of a back swing, a down swing and a follow through, and assigns a path in two-dimensional coordinates having a vertical axis and a horizontal axis, to any two golf swing paths among the back swing, the down swing and the follow through;
a characteristic amount extraction unit which calculates a distance in a horizontal direction between any two points on the golf swing path, for each of the two golf swing paths; and
a statistical processing unit which classifies the golf swing on the basis of a distance difference between the respective distances in the horizontal direction thus calculated.

6. An analysis method for an analysis system that includes:
a head measurement apparatus which measures a head speed of a golf club when a player strikes a golf ball with the golf club;
an imaging unit which captures still images on the basis of the head speed measured by the head measurement apparatus;
an acquisition apparatus which acquires swing data, which is data during a golf swing of the player; and
a data processing apparatus which analyzes the golf swing on the basis of the swing data,
the analysis method comprising:
a process in which the head measurement apparatus measures the head speed of the player, the imaging unit captures the still images used for computing the state of motion of the golf ball on the basis of the measured head speed, and the data processing apparatus computes the state of motion of the golf ball on the basis of the still images captured by the imaging unit; and
a process in which the acquisition apparatus acquires the swing data; and the data processing apparatus: divides the golf swing identified by the swing data into golf swing paths of a back swing, a down swing and a follow through, and assigns a path in two-dimensional coordinates having a vertical axis and a horizontal axis, to any two golf swing paths among the back swing, the down swing and the follow through; calculates a distance in a horizontal direction between any two points on the golf swing path, for each of the two golf swing paths; and classifies the golf swing on the basis of a distance difference between the respective distances in the horizontal direction thus calculated.

7. An analysis system which analyzes a golf swing when a player strikes a golf ball with a golf club, comprising:
an imaging unit which captures a plurality of still images close to a moment of impact when the golf club is swung;
an acquisition apparatus which acquires swing data, which is data during a golf swing of the player; and
a data processing apparatus which analyzes the golf swing on the basis of the swing data and also measures a behavior of a face of a club head of the golf club on the basis of the still images captured by the imaging unit,
wherein the data processing apparatus includes:
a storage unit which stores a positional relationship between at least three markers arranged on the club head of the golf club, and the face of the club head; and
a computation unit which measures the behavior of the face of the club head during a swing on the basis of positions of the markers contained in the captured still images, by using the positional relationship stored in the storage unit, and
the computation unit includes:
a measurement unit which divides the golf swing identified by the swing data into golf swing paths of a back swing, a down swing and a follow through, and assigns a path in two-dimensional coordinates having a vertical axis and a horizontal axis, to any two golf swing paths among the back swing, the down swing and the follow through;
a characteristic amount extraction unit which calculates a distance in a horizontal direction between any two points on the golf swing path, for each of the two golf swing paths; and
a statistical processing unit which classifies the golf swing on the basis of a distance difference between the respective distances in the horizontal direction thus calculated.

8. An analysis method for an analysis system that includes:
an imaging unit which captures a plurality of still images close to a moment of impact when a golf club is swung by a player;
an acquisition apparatus which acquires swing data, which is data during a golf swing of the player; and
a data processing apparatus which analyzes the golf swing on the basis of the swing data and also measures a behavior of a face of a club head of the golf club on the basis of the still images captured by the imaging unit,
the analysis method comprising:
a process in which the imaging unit captures a plurality of still images close to the moment of impact when the golf club is swung; and the data processing apparatus measures the behavior of the face of the club head during a swing on the basis of positions of at least three markers arranged on the club head of the golf club and contained in the captured still images, by using a positional relationship between the markers and the face of the club head, this positional relationship being previously stored in a storage unit; and
a process in which the acquisition apparatus acquires the swing data; and the data processing apparatus: divides the golf swing identified by the swing data into golf swing paths of a back swing, a down swing and a follow through, and assigns a path in two-dimensional coordinates having a vertical axis and a horizontal axis, to any two golf swing paths among the back swing, the down swing and the follow through; calculates a distance in a horizontal direction between any two points on the golf swing path, for each of the two golf swing paths; and classifies the golf swing on the basis of a distance difference between the respective distances in the horizontal direction thus calculated.
